(19) United States
(12) Patent Application Publication
(10) Pub. No.: US 2026/0121571 A1
(43) Pub. Date: Apr. 30, 2026

(54) POWER TOOL

(71) Applicant: Nanjing Chervon Industry Co., Ltd., Nanjing (CN)

(72) Inventors: Ju Li, Nanjing (CN); Cunrong Huang, Nanjing (CN)

(21) Appl. No.: 19/003,637

(22) Filed: Dec. 27, 2024

Related U.S. Application Data
(63) Continuation of application No. PCT/CN2023/107698, filed on Jul. 17, 2023.

(30) Foreign Application Priority Data
Aug. 11, 2022 (CN) 202210962444.8
Aug. 11, 2022 (CN) 202210962954.5
Aug. 11, 2022 (CN) 202210962992.0
Aug. 11, 2022 (CN) 202210967041.2

(51) Int. Cl. H02P 29/68; B25F 5/02; H02K 7/14; H02K 11/33

(52) U.S. Cl. CPC H02P 29/68; B25F 5/02; H02K 7/145; H02K 11/33; H02K 2211/03

(57) ABSTRACT

A power tool includes an electric motor; a housing; a first energy storage device including at least one first energy storage unit, where the first energy storage device is detachably mounted to the housing and further configured to be detachable from the housing to supply power to another power tool; a second energy storage device including at least one second energy storage unit; a charging circuit electrically connected to the second energy storage device and the first energy storage device; and a controller configured to control the charging circuit such that the first energy storage device charges the second energy storage device.

### RELATED APPLICATION INFORMATION

This application is a continuation of International Application Number PCT/CN2023/107698, filed on Jul. 17, 2023, through which this application also claims the benefit under 35 U.S.C. § 119(a) of Chinese Patent Application No. 202210962992.0, filed on Aug. 11, 2022, Chinese Patent Application No. 202210962954.5, filed on Aug. 11, 2022, Chinese Patent Application No. 202210962444.8, filed on Aug. 11, 2022, and Chinese Patent Application No. 202210967041.2, filed on Aug. 11, 2022 which applications are incorporated herein by reference in their entireties.

### TECHNICAL FIELD

The present application relates to the technical field of power tools and, in particular, to an electronic combination, a battery pack, and a power tool and a charging control method therefor.

### BACKGROUND

With the development of battery technology, engine tools are gradually replaced with power tools. In order that a cordless power tool has a better use effect, a battery pack is required to have higher output characteristics. For example, to achieve working performance similar to that of an engine machine, the battery pack is required to have a relatively large rated power and capacity. Moreover, with the diversified types of power tools, the battery pack is also required to be able to support the power tools in working at relatively low temperatures. For example, snow throwers usually work in low temperature environments.

### SUMMARY

A power tool includes an electric motor; a housing configured to at least partially surround the electric motor; a first energy storage device configured to drive the electric motor to rotate and including at least one first energy storage unit, where the first energy storage device is detachably mounted to the housing and further configured to be detachable from the housing to supply power to another power tool; a second energy storage device including at least one second energy storage unit; a charging circuit electrically connected to the second energy storage device and the first energy storage device; and a controller configured to control the charging circuit such that the first energy storage device charges the second energy storage device.

In an example, the at least one second energy storage unit is a capacitor battery.

In an example, an Internet of things module is further included, where the Internet of things module is electrically connected to the second energy storage device, and the second energy storage device supplies power to the Internet of things module.

In an example, a lighting device is further included, where the lighting device is electrically connected to the second energy storage device, and the second energy storage device supplies power to the lighting device.

In an example, the second energy storage device is disposed in the housing.

In an example, the capacity ratio of the second energy storage device to the first energy storage device is less than or equal to 1.

A charging control method for a power tool is provided. The power tool includes a housing; a first energy storage device including at least one first energy storage unit, where the first energy storage device is detachably mounted to the housing and further configured to be detachable from the housing to supply power to another power tool; and a second energy storage device including at least one second energy storage unit and electrically connected to the first energy storage device. The control method includes detecting the remaining power of the first energy storage device and the remaining power of the second energy storage device; and according to the remaining power of the first energy storage device and the remaining power of the second energy storage device, controlling the first energy storage device to charge the second energy storage device.

In an example, that according to the remaining power of the first energy storage device and the remaining power of the second energy storage device, the first energy storage device is controlled to charge the second energy storage device includes the step below.

When the remaining power of the first energy storage device is greater than or equal to first preset power and the remaining power of the second energy storage device is less than or equal to second preset power, the first energy storage device is controlled to charge the second energy storage device.

An electronic combination includes a power tool and a charger. The power tool includes an electric motor; a housing configured to at least partially surround the electric motor; and an energy storage device configured to drive the electric motor to rotate, including at least one capacitor battery, and disposed in the housing. The charger is configured to be able to charge the energy storage device and includes a charging interface. When the charger charges the energy storage device, the charging interface is close to the housing.

In an example, a charge rate at which the charger charges the energy storage device is greater than or equal to 5 C and less than 50 C.

In an example, the energy storage device includes contact terminals exposed on a surface of the housing, and the charging interface includes terminals matching the contact terminals.

In an example, the energy storage device is closely attached to the inside of the housing, and the charging interface includes a wireless charging coil.

In an example, the power tool further includes a battery pack coupling portion for detachably mounting a battery pack able to charge the energy storage device.

An electronic combination includes a charger, a first energy storage device, and a second energy storage device. The first energy storage device includes a first housing; at least one first energy storage unit accommodated in the first housing; and a first interface disposed on the first housing and including a first positive terminal, a first negative terminal, and a first communication terminal. The second energy storage device includes a second housing; at least one second energy storage unit accommodated in the second housing; and a second interface disposed on the second housing and including a second positive terminal, a second negative terminal, and a second communication terminal. The charger includes a charging mode setting unit operable by a user to set a charging mode, where the charging mode includes at least a normal charging mode and a fast charging mode; and a charging interface including at least a positive terminal, a negative terminal, and a communication terminal and couplable to both the first interface and the second interface. The charger further includes an identification unit and a control unit, where the identification unit is electrically connected to the communication terminal and configured to acquire a type of an energy storage device coupled to the charging interface; and the control unit is electrically connected to the identification unit and the charging mode setting unit. When the charging interface is coupled to the first energy storage device, the control unit controls the charger to charge the first energy storage device in the normal charging mode. When the charging interface is coupled to the second energy storage device, the control unit controls the charger to charge the second energy storage device in the charging mode set by the charging mode setting unit.

In an example, a charge rate in the normal charging mode is less than 5 C.

In an example, a charge rate in the fast charging mode is greater than or equal to 5 C and less than 50 C.

In an example, the width ratio of the first positive terminal to the second positive terminal is greater than or equal to 2.

In an example, the width ratio of the first negative terminal to the second negative terminal is greater than or equal to 2.

In an example, the at least one first energy storage unit is a ternary lithium battery.

In an example, the at least one first energy storage unit is a lithium iron phosphate battery.

In an example, the at least one second energy storage unit is a capacitor battery.

In an example, the charging interface includes two sets of positive and negative terminals.

In an example, the two sets of positive and negative terminals are retractable.

An electronic combination includes a charger, a first energy storage device, and a second energy storage device. The first energy storage device includes a first housing; at least one first energy storage unit accommodated in the first housing; and a first interface disposed on the first housing. The second energy storage device includes a second housing; at least one second energy storage unit accommodated in the second housing; and a second interface disposed on the second housing. The charger includes a charging mode setting unit operable by a user to set a charging mode, where the charging mode includes at least a normal charging mode and a fast charging mode; a first charging interface couplable to the first interface; and a second charging interface couplable to the second interface. The charger further includes a control unit electrically connected to the first charging interface, the second charging interface, and the charging mode setting unit separately. When the first charging interface is coupled to the first energy storage device, the control unit controls the charger to charge the first energy storage device in the normal charging mode. When the second charging interface is coupled to the second energy storage device, the control unit controls the charger to charge the second energy storage device in the charging mode set by the charging mode setting unit.

In an example, a charge rate in the normal charging mode is less than 5 C.

In an example, a charge rate in the fast charging mode is greater than or equal to 5 C and less than 50 C.

In an example, the at least one first energy storage unit is a ternary lithium battery.

In an example, the at least one first energy storage unit is a lithium iron phosphate battery.

In an example, the at least one second energy storage unit is a capacitor battery.

In an example, the first charging interface includes a first charging positive terminal, a first charging negative terminal, and a first charging communication terminal; and the second charging interface includes a second charging positive terminal, a second charging negative terminal, and a second charging communication terminal.

In an example, the width ratio of a first positive terminal to a second positive terminal is greater than 2.

In an example, the width ratio of a first negative terminal to a second negative terminal is greater than 2.

A battery pack for supplying power to a power tool includes a housing; a power tool interface connected to the power tool and including a terminal assembly; and multiple cell units accommodated in the housing, where the multiple cell units are connected in a combination of series and parallel connections and electrically connected to the terminal assembly; and the multiple cell units are capacitor batteries.

A power tool includes an electric motor; a housing configured to at least partially surround the electric motor; and a first energy storage device supplying power to the electric motor and including at least one first energy storage unit. The power tool further includes a second energy storage device including at least one capacitor battery; and a switch circuit disposed between the second energy storage device and the electric motor. When a voltage of the first energy storage device is lower than a voltage of the second energy storage device, the switch circuit is closed so that the second energy storage device supplies power to the electric motor.

In an example, the first energy storage device is detachably mounted to the housing and further configured to be detachable from the housing to supply power to another power tool.

In an example, the switch circuit includes a diode.

In an example, the switch circuit further includes a synchronous rectifier.

In an example, the switch circuit includes a field-effect transistor.

In an example, the power tool further includes a controller configured to detect voltages at two ends of the field-effect transistor and control the field-effect transistor to turn on or off.

In an example, in the switch circuit, the width of a printed circuit board (PCB) copper foil is greater than or equal to 1.5 cm.

In an example, in the switch circuit, a PCB copper foil is windowed.

A power tool includes an electric motor; a housing configured to at least partially surround the electric motor; a controller configured to control the electric motor to rotate; and a first energy storage device supplying power to the electric motor and including at least one first energy storage unit. The power tool further includes a second energy storage device including at least one capacitor battery; and a switch circuit disposed between the second energy storage device and the electric motor. The controller controls, according to at least one working parameter, the switch circuit to be closed so that the second energy storage device supplies power to the electric motor.

In an example, the at least one working parameter includes a state of charge (SoC).

In an example, the at least one working parameter includes a state of health (SoH).

A power tool includes an electric motor; a housing configured to at least partially surround the electric motor; a battery pack interface disposed on the housing and configured to be couplable to a first energy storage device and a second energy storage device separately, where the first energy storage device is able to supply power to the electric motor when coupled to the battery pack interface, and the second energy storage device is able to supply power to the electric motor when coupled to the battery pack interface. A discharge rate of at least one of the first energy storage device and the second energy storage device is greater than or equal to 10 C and less than or equal to 50 C.

In an example, the first energy storage device includes a first energy storage unit and the second energy storage device includes a second energy storage unit.

In an example, the second energy storage unit is a capacitor battery.

In an example, a shape of the battery pack interface matches a shape of a charging interface of the first energy storage device and a shape of a charging interface of the second energy storage device.

A power tool includes an electric motor; a housing configured to at least partially surround the electric motor; a power supply assembly including a first energy storage device and a second energy storage device and supplying power to the electric motor. A discharge rate of at least one of the first energy storage device and the second energy storage device is greater than or equal to 10 C and less than or equal to 50 C.

In an example, the second energy storage device includes a capacitor battery.

In an example, a discharge unit is further included, where the discharge unit includes a first discharge switch. When the first discharge switch is turned on, the first energy storage device supplies power to the electric motor. The discharge unit further includes a second discharge switch. When the second discharge switch is turned on, the second energy storage device supplies power to the electric motor.

In an example, the power tool is an impact power tool.

In an example, when the power tool is in a stable working condition, the first discharge switch is turned on; when the power tool is in a large-current working condition, the first discharge switch and the second discharge switch are turned on at the same time.

In an example, when the power tool works in the stable working condition, the discharge rate of at least one of the first energy storage device and the second energy storage device is less than or equal to 30 C; when the power tool works in the large-current working condition, the discharge rate of at least one of the first energy storage device and the second energy storage device is greater than 30 C.

A power tool includes a housing; an electric motor mounted to the housing, where the housing at least partially accommodates the electric motor; a first energy storage device supplying power to the electric motor and including at least one first energy storage unit; a controller configured to at least control the first energy storage device to supply power to the electric motor; and a temperature detection device configured to detect the temperature of the first energy storage device and send the temperature to the controller. The power tool further includes a second energy storage device including at least one second energy storage unit. When the temperature of the first energy storage device is lower than or equal to a first preset temperature and higher than or equal to a second preset temperature, the controller controls the second energy storage device to preheat the first energy storage device.

In an example, the temperature detection device is disposed in the first energy storage device.

In an example, the housing is formed with a mounting portion, the first energy storage device is mounted to the mounting portion, and the temperature detection device is disposed on the mounting portion.

In an example, the at least one second energy storage unit is a capacitor battery.

In an example, when the controller controls the second energy storage device to preheat the first energy storage device, the second energy storage device discharges to a load, and the load is adjacent to the first energy storage device.

In an example, the second energy storage device is physically connected to the first energy storage device through a thermally conductive material.

In an example, the second energy storage device is adjacent to the first energy storage device.

In an example, a power-on unit is further included, where the power-on unit is configured to send a first signal to the controller. When the controller receives the first signal and the temperature of the first energy storage device is lower than or equal to the first preset temperature and higher than or equal to the second preset temperature, the controller controls the second energy storage device to preheat the first energy storage device.

In an example, the power-on unit includes an actuator, and when the actuator is operated to a preset position, the power-on unit sends the first signal to the controller.

In an example, a wireless communication interface is further included, where the wireless communication interface is used for making the power tool communicatively connected to a remote device. When receiving a standby signal sent by the remote device, the power-on unit sends the first signal to the controller.

A power tool includes a housing; an electric motor mounted to the housing, where the housing at least partially accommodates the electric motor; a circuit board assembly configured to drive the electric motor to rotate; an energy storage device including at least one energy storage unit and connected to the circuit board assembly; a temperature detection device configured to detect the temperature of at least one element of the circuit board assembly and send the temperature to a controller; and the controller configured to control the energy storage device to preheat the at least one element of the circuit board assembly when the temperature sent by the temperature detection device is lower than or equal to a first preset temperature and higher than or equal to a second preset temperature.

In an example, the controller is disposed on the circuit board assembly.

In an example, the circuit board assembly includes a low temperature resistant electronic element.

In an example, the circuit board assembly includes an electronic element that is not resistant to low temperatures.

In an example, the at least one energy storage unit is a capacitor battery.

In an example, the energy storage device supplies power to the electric motor through the circuit board assembly.

In an example, the power tool further includes a second energy storage device supplying power to the electric motor.

In an example, the energy storage device is adjacent to the circuit board assembly.

In an example, the energy storage device is physically connected to the circuit board assembly through a thermally conductive material.

In an example, the circuit board assembly includes a resistor, and the energy storage device discharges to the resistor to preheat the circuit board assembly.

A power tool includes an electric motor; a handle for a user to hold; an energy storage device including at least one energy storage unit; a controller configured to at least control the electric motor; and a temperature detection device configured to detect the temperature of the handle and send the temperature to the controller. When the temperature of the handle is lower than or equal to a first preset temperature and higher than or equal to a second preset temperature, the controller controls the energy storage device to preheat the handle.

In an example, the at least one energy storage unit is a capacitor battery.

In an example, the energy storage device is disposed in the handle.

A power tool includes a housing; a handle mounted to the housing and used for a user to hold; an electric motor mounted to the housing, where the housing at least partially accommodates the electric motor; an energy storage device including at least one energy storage unit; a controller configured to at least control the electric motor and disposed on a circuit board assembly; and a temperature detection device configured to detect the ambient temperature and send the ambient temperature to the controller. The controller is configured to control the energy storage device to preheat the circuit board assembly or the handle when the temperature sent by the temperature detection device is lower than or equal to a first preset temperature and higher than or equal to a second preset temperature.

In an example, a second energy storage device is further included, where the second energy storage device supplies power to the electric motor, and the controller is configured to control the energy storage device to preheat the second energy storage device when the temperature sent by the temperature detection device is lower than or equal to the first preset temperature and higher than or equal to the second preset temperature.

A power tool includes an electric motor; a housing at least partially surrounding the electric motor; and a battery pack interface disposed on the housing and configured to be couplable to a first energy storage device and a second energy storage device separately, where the first energy storage device is able to supply power to the electric motor when coupled to the battery pack interface, and the second energy storage device is able to supply power to the electric motor when coupled to the battery pack interface. When the battery pack interface is coupled to the first energy storage device, the working temperature of the power tool is higher than or equal to a first preset temperature, and when the battery pack interface is coupled to the second energy storage device, the working temperature of the power tool is higher than or equal to a second preset temperature, where the first preset temperature is higher than the second preset temperature.

In an example, when the battery pack interface is coupled to the second energy storage device, a working temperature range of the power tool is higher than or equal to −40° C. and lower than or equal to 85° C.

In an example, when the battery pack interface is coupled to the first energy storage device, a working temperature range of the power tool is higher than or equal to −20° C. and lower than or equal to 70° C.

A power tool includes an electric motor; a housing configured to at least partially surround the electric motor; a power supply assembly including a first energy storage device and a second energy storage device, where the first energy storage device includes at least one first energy storage unit, the second energy storage device includes at least one second energy storage unit, and the power supply assembly supplies power to the electric motor; a controller configured to at least control the power supply assembly to supply power to the electric motor; and a temperature detection device configured to detect the temperature of the power supply assembly and send the temperature to the controller. When the temperature of the power supply assembly is lower than or equal to a first preset temperature and higher than or equal to a second preset temperature, the controller selects the second energy storage device to supply power to the electric motor.

In an example, the at least one second energy storage unit is a capacitor battery.

A power tool includes an electric motor; and a housing configured to at least partially surround the electric motor and formed with a mounting portion. The power tool further includes a capacitor battery mounted to the mounting portion.

In an example, the capacitor battery is cylindrical and has a length less than or equal to 70 mm.

In an example, the capacitor battery is cylindrical and has a diameter greater than or equal to 50 mm and less than or equal to 200 mm.

In an example, the housing is further formed with a handle for a user to hold, and the mounting portion is disposed on the handle.

In an example, the housing includes two opposite halves, and the mounting portion is formed on at least one of the two opposite halves.

In an example, a battery pack interface is further included, where the battery pack interface is used for mounting a battery pack able to drive the electric motor.

In an example, when the battery pack is electrically connected to the battery pack interface, power is transmittable between the battery pack and the capacitor battery.

In an example, an Internet of things module is further included, where the Internet of things module is electrically connected to the capacitor battery, and the capacitor battery supplies power to the Internet of things module.

In an example, a lighting device is further included, where the lighting device is electrically connected to the capacitor battery, and the capacitor battery supplies power to the lighting device.

A power tool includes an electric motor; and a housing configured to at least partially surround the electric motor and formed with a first mounting portion and a second mounting portion, where the first mounting portion is used for mounting a first energy storage device configured to be able to supply power to the electric motor and including at least one first energy storage unit; the second mounting portion is used for mounting a second energy storage device configured to be able to supply power to the electric motor and including at least one second energy storage unit; the first mounting portion includes a first interface including a first positive terminal, a first negative terminal, and a first communication terminal; and the second mounting portion includes a second interface including a second positive terminal, a second negative terminal, and a second communication terminal.

The first positive terminal or the second positive terminal is able to withstand a current greater than or equal to 100 A.

In an example, when the first energy storage device is disconnected, the second energy storage device supplies power to the electric motor.

In an example, the at least one second energy storage unit is a capacitor battery.

In an example, the second positive terminal is able to continuously withstand a current greater than or equal to 100 A for a maximum of 5 seconds.

A power tool includes an electric motor; a housing configured to at least partially surround the electric motor; and a battery pack interface disposed on the housing and configured to be couplable to a first energy storage device and a second energy storage device separately, where the first energy storage device is able to supply power to the electric motor when coupled to the battery pack interface and includes at least one first energy storage unit, and the second energy storage device is able to supply power to the electric motor when coupled to the battery pack interface and includes at least one second energy storage unit. The battery pack interface includes a first positive terminal, a second positive terminal, a first negative terminal, a second negative terminal, and a common communication terminal, where the second positive terminal and the second negative terminal are able to withstand a current greater than or equal to 100 A.

In an example, the second positive terminal and the second negative terminal are able to continuously withstand a current greater than or equal to 100 A for a maximum of 5 seconds.

In an example, the first positive terminal, the second positive terminal, the first negative terminal, and the second negative terminal are all retractable.

In an example, the first energy storage device and the second energy storage device are each provided with avoidance terminals.

In an example, the first positive terminal, the first negative terminal, the second positive terminal, and the second negative terminal are located at four corners of a rectangle, and the common communication terminal is located at the center of the rectangle.

In an example, the at least one second energy storage unit is a capacitor battery.

It is to be understood that the content described in this part is neither intended to identify key or important features of examples of the present application nor intended to limit the scope of the present application. Other features of the present application are apparent from the description provided hereinafter.

### BRIEF DESCRIPTION OF THE DRAWINGS

To illustrate technical solutions in examples of the present application more clearly, the drawings used in the description of the examples are briefly described below. Apparently, the drawings described below illustrate only part of examples of the present application, and those of ordinary skill in the art may obtain other drawings based on the drawings described below on the premise that no creative work is done.

FIG. 1 is a structural view of a power tool according to an example of the present application.

FIG. 2 is a structural view of a battery pack mounting portion of a power tool according to an example of the present application.

FIG. 3 is a structural view of power tools according to an example of the present application.

FIG. 4 is a structural view of a power tool according to an example of the present application.

FIG. 5 is a block diagram of a power tool according to another example of the present application.

FIG. 6 is a block diagram of a power tool according to another example of the present application.

FIG. 7 is a block diagram of a power tool according to another example of the present application.

FIG. 8 is a block diagram of a power tool according to another example of the present application.

FIG. 9 is a block diagram of a power tool according to another example of the present application.

FIG. 10 is a flowchart of a control method for a power tool according to an example of the present application.

FIG. 11 is a block diagram of an electronic combination according to an example of the present application.

FIG. 12 is a block diagram of an electronic combination according to an example of the present application.

FIG. 13 is a block diagram of an electronic combination according to another example of the present application.

FIG. 14 is a block diagram of an electronic combination according to another example of the present application.

FIG. 15 is a block diagram of an electronic combination according to another example of the present application.

FIG. 16 is a block diagram of an electronic combination according to another example of the present application.

FIG. 17 is a structural view of a charger in an electronic combination according to another example of the present application.

FIG. 18 is a block diagram of a power tool according to another example of the present application.

FIG. 19 is a block diagram of a power tool according to another example of the present application.

FIG. 20 is a block diagram of a power tool according to another example of the present application.

FIG. 21 is a block diagram of a power tool according to another example of the present application.

FIG. 22 is a block diagram of a power tool according to another example of the present application.

FIG. 23 is a block diagram of a power tool according to another example of the present application.

FIG. 24 is a block diagram of a power tool according to another example of the present application.

FIG. 25 is a block diagram of a power tool according to another example of the present application.

FIG. 26 is a block diagram of a power tool according to another example of the present application.

FIG. 27 is a block diagram of a power tool according to another example of the present application.

FIG. 28 is a block diagram of a power tool according to another example of the present application.

FIG. 29 is a block diagram of a power tool according to another example of the present application.

FIG. 30 is a block diagram of a power tool according to another example of the present application.

FIG. 31 is a block diagram of a power tool according to another example of the present application.

FIG. 32 is a block diagram of a power tool according to another example of the present application.

FIG. 33 is a block diagram of a power tool according to another example of the present application.

FIG. 34 is a block diagram of a power tool according to another example of the present application.

FIG. 35 is a flowchart of a preheating method for a power tool according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. For example, direct connection means that two members or assemblies are connected together without intermediaries, and indirect connection means that two members or assemblies are respectively connected with at least one intermediate member and the two members or assemblies are connected by the at least one intermediate member. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, one assembly, or a combination of members.

In this application, the terms “up”, “down”, “left”, “right”, “front”, “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

An existing battery pack adapted to a power tool usually requires to be charged for several hours. Therefore, during use of the power tool, if the power of the battery pack is used up, a user needs to detach the battery pack from the power tool, charge the battery pack for a relatively long time, and re-mount the battery pack to the power tool for continued use, causing inconvenience to the user.

In examples of the present application, a power tool system may include various types of power tools, such as a handheld power tool, a garden power tool, and a smart power tool. In an example, a power tool in a tool system may be powered by at least one energy storage device, where the so-called energy storage device is a battery pack that can store and release electrical energy. For example, the power tool may be powered by a battery pack built into the tool or a battery pack detachably mounted to the power tool or powered by the two battery packs at the same time.

The power tool is provided with a housing or a mounting portion for mounting the battery pack built into the power tool or the battery pack detachably mounted to the power tool.

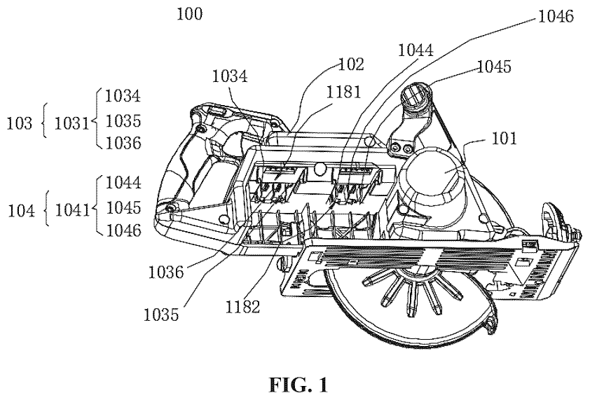

In an example, when a power tool 100 has two energy storage devices, as shown in FIG. 1, a housing 102 is formed with a first mounting portion 1181 and a second mounting portion 1182. The first mounting portion 1181 is used for mounting a first energy storage device 103, the first energy storage device 103 is configured to be able to supply power to an electric motor 101, and the first energy storage device 103 includes at least one first energy storage unit 1031. The second mounting portion 1182 is used for mounting a second energy storage device 104, the second energy storage device 104 is configured to be able to supply power to the electric motor 101, and the second energy storage device 104 includes at least one second energy storage unit 1041. In this example, the power tool can work when the two energy storage devices supply power or when only one energy storage device supplies power.

In an example, the first energy storage device 103 may be fixedly mounted to the first mounting portion 1181 or detachably mounted to the first mounting portion 1181, and the second energy storage device 104 may be fixedly mounted to the second mounting portion 1182 or detachably mounted to the second mounting portion 1182.

In an example, the power tool may include at least one battery pack interface connectable to at least one external energy storage device, where one end of the battery pack interface is connected to the built-in battery pack and/or the detachable battery pack of the power tool, and the other end of the battery pack interface is connected to the external energy storage device so that the external energy storage device supplies power to the built-in battery pack and/or the detachable battery pack of the power tool. Alternatively, one end of the battery pack interface is connected to the electric motor, and the other end of the battery pack interface is connected to the external energy storage device so that the external energy storage device supplies power to the electric motor. Optionally, a shape of the battery pack interface 112 is required to match a shape of a charging interface of the first energy storage device 103 and a shape of a charging interface of the second energy storage device 104.

In an example, as shown in FIG. 1, when two battery pack interfaces are provided, a first battery pack interface 1033 may be disposed in the first mounting portion 1181, and the first battery pack interface 1033 includes a first positive terminal 1034, a first negative terminal 1035, and a first communication terminal 1036. A second battery pack interface 1043 may be disposed in the second mounting portion 1182, and the second battery pack interface 1043 includes a second positive terminal 1044, a second negative terminal 1045, and a second communication terminal 1046.

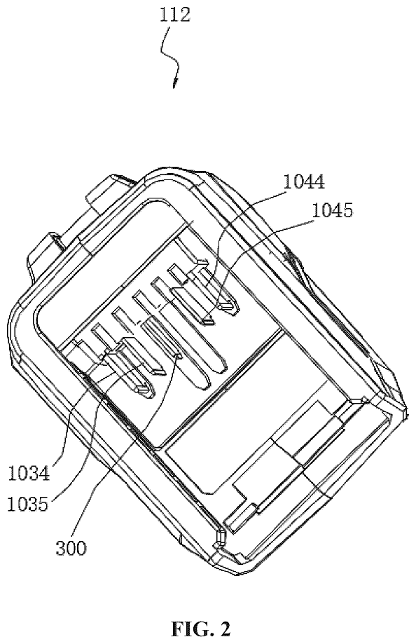

One battery pack interface may be provided. As shown in FIG. 2, when one battery pack interface is provided, the battery pack interface may be provided with the first positive terminal 1034, the first negative terminal 1035, the first communication terminal, the second positive terminal 1044, the second negative terminal 1045, and the second communication terminal. The first positive terminal 1034, the first negative terminal 1035, and the first communication terminal are coupled to the first energy storage device 103, and the second positive terminal 1044, the second negative terminal 1045, and the second communication terminal are coupled to the second energy storage device 104. Optionally, the first positive terminal 1034, the first negative terminal 1035, the second positive terminal 1044, and the second negative terminal 1045 are located at the four corners of a rectangle, and a common communication terminal 300 is located at the center of the rectangle. Alternatively, the first positive terminal 1034, the first negative terminal 1035, the common communication terminal 300, the second negative terminal 1045, and the second positive terminal 1044 are arranged in sequence.

In an example, as shown in FIG. 2, when one battery pack interface is provided, one communication terminal 300 may serve as both the first communication terminal and the second communication terminal. That is to say, the one battery pack interface includes the first positive terminal 1034, the first negative terminal 1035, the second positive terminal 1044, the second negative terminal 1045, and the common communication terminal 300. It is to be understood that when the power tool 100 is compatible with the first energy storage device 103 and the second energy storage device 104, one battery pack interface 112 may be provided, and the battery pack interface 112 is provided with the first positive terminal 1034 and the first negative terminal 1035 for connecting the first energy storage device 103, the second positive terminal 1044 and the second negative terminal 1045 for connecting the second energy storage device 104, and the common communication terminal 300 for communicating with the external energy storage device, where the first energy storage device 103 and the second energy storage device 104 can share the communication terminal. Thus, space can be saved and an opening of the housing 102 can be saved.

In the preceding example, the first positive terminal 1034, the second positive terminal 1044, the first negative terminal 1035, and the second negative terminal 1045 are all retractable to prevent the terminals from being exposed when not in use and prevent a short circuit between terminals.

In the preceding example, the first positive terminal 1034 or the second positive terminal 1044 can withstand a current greater than or equal to 100 A. The second positive terminal 1044 can continuously withstand a current greater than or equal to 100 A for a maximum of 5 seconds. The second negative terminal 1045 can withstand a current greater than or equal to 100 A. Thus, a requirement for a fast charging mode is satisfied by using a capacitor battery.

Optionally, the width ratio of the first positive terminal to the second positive terminal is greater than 2.

Optionally, the width ratio of the first negative terminal to the second negative terminal is greater than 2.

Optionally, the first positive terminal 1034, the first negative terminal 1035, the first communication terminal, the second positive terminal 1044, the second negative terminal 1045, and the second communication terminal in the preceding example are all retractable to prevent the terminals from being exposed out of the power tool 100 and prevent damages or the short circuit.

How the battery pack interface is connected to the external energy storage device and how the external energy storage device charges the first energy storage device and the second energy storage device through the battery pack interface are described later, and the related description is omitted here.

In an example, the battery pack interface may be further provided with avoidance terminals so that when the external energy storage device is connected, external energy storage devices with different numbers of terminals can match the battery pack interface.

In an example, the first energy storage unit may be a ternary lithium battery or a lithium iron phosphate battery or the capacitor battery, and the second energy storage unit may be the capacitor battery. In an example, the first energy storage device and the second energy storage device may simultaneously supply power to different modules in the power tool. For example, the first energy storage device may provide electrical energy as main power supply for the electric motor, and the second energy storage device may provide electrical energy as auxiliary power supply for another function module such as a control module or an Internet of things module or a lighting module in the tool. In an example, the first energy storage device may supply power to the power tool and also charge the second energy storage device; and the second energy storage device may supply power to the power tool and also charge the first energy storage device. Charge and discharge manners between the two energy storage devices are described later and are not described in detail here.

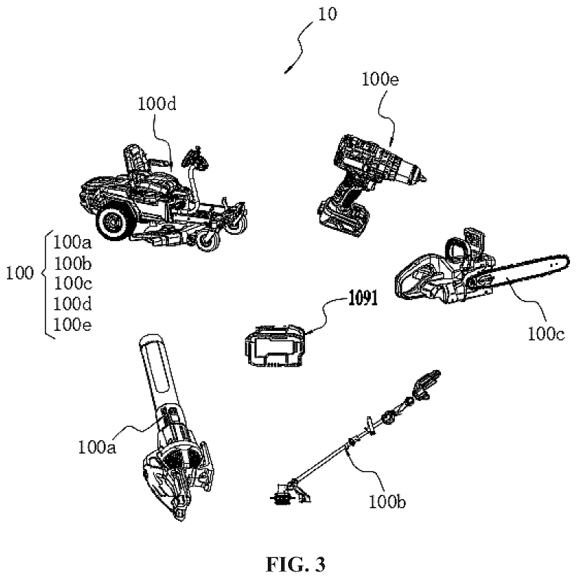

In an example, the energy storage device for powering the power tool may be the capacitor battery. Referring to a tool system 10 shown in FIG. 3, the tool system 10 may include a capacitor battery 1091 and the power tool 100, where the power tool 100 may be a blower 100a, a string trimmer 100b, a chainsaw 100c, a riding mower 100d, or an electric drill 100e. In different tool systems, the capacitor battery 1091 may be detachably mounted to a mounting portion 118 of the power tool or may be fixed to the mounting portion 118. In this example, the string trimmer is used as an example of the power tool, and other types of power tools are not listed one by one.

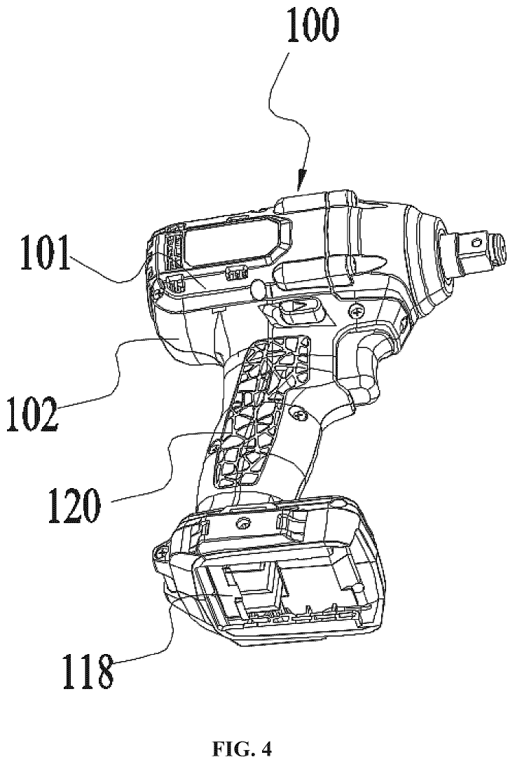

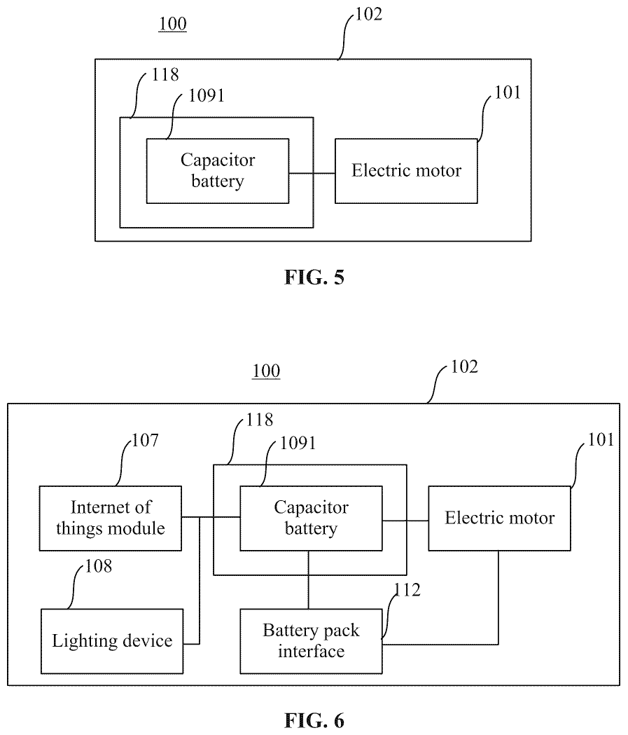

In an example, when the power tool 100 has one energy storage device, as shown in FIGS. 4 and 5, the power tool 100 includes the electric motor 101 and the housing 102.

The housing 102 is configured to at least partially surround the electric motor 101 and formed with the mounting portion 118.

The power tool 100 further includes the capacitor battery 1091 mounted to the mounting portion 118.

Since the capacitor battery 1091 can discharge at a large rate and has the advantages of a low cost, a long battery life, high safety, a long lifetime, fast charging, small space occupied, and easy detection of an SoC of the battery, the power tool 100 is powered by the capacitor battery 1091 to improve the performance of the power tool 100.

In an example, the capacitor battery 1091 may include multiple capacitor cells, and the capacitor cells may be cylindrical and have a length less than or equal to 70 mm and a diameter greater than or equal to 50 mm and less than or equal to 200 mm.

In an example, a shape of the mounting portion 118 may exactly match a shape of the capacitor battery 1091 so that the capacitor battery 1091 is mounted.

Optionally, as shown in FIG. 4, the housing 102 is further formed with a handle 120 for the user to hold, and the mounting portion 118 may be disposed on the handle 120.

In an example, the mounting portion 118 may be disposed on the handle 120 of the power tool 100, thereby saving space in a body of the power tool 100.

Optionally, the housing 102 includes two opposite halves, and the mounting portion 118 is formed on at least one of the two opposite halves.

In an example, the mounting portion 118 may be disposed on the housing 102. If the mounting portion 118 is cylindrical, a half cylinder may be disposed on a half of the housing, and the other half cylinder may be disposed on the other half of the housing so that when the housing is formed, the two half cylinders may be combined into the cylindrical mounting portion. In another example, the cylindrical mounting portion 118 may be disposed on a half of the housing 102.

Optionally, as shown in FIG. 6, the power tool 100 further includes an Internet of things module 107 electrically connected to the capacitor battery 1091, and the capacitor battery 1091 supplies power to the Internet of things module 107.

Optionally, as shown in FIG. 6, a lighting device 108 is further included, where the lighting device 108 is electrically connected to the capacitor battery 1091, and the capacitor battery 1091 supplies power to the lighting device 108.

The Internet of things module 107 is disposed in the power tool 100 and enables the power tool 100 to communicate with another terminal, such as a computer terminal, a mobile phone terminal, another power tool, a battery pack, or an adapter, so that another terminal can monitor performance parameters of the energy storage device in the power tool 100. The lighting device 108 may be turned on when the power tool 100 needs light for working. For example, during working at night or in an environment with poor light, the lighting device 108 may be turned on.

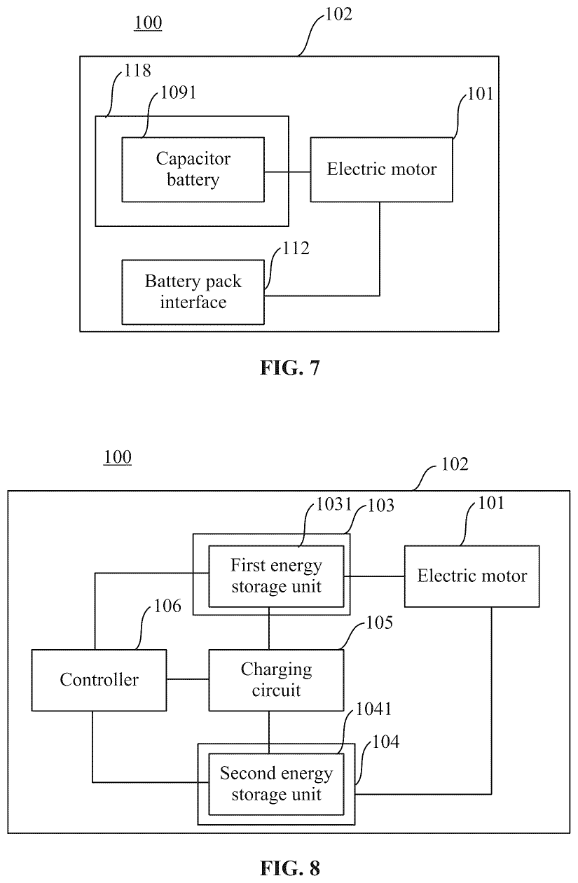

In an example, as shown in FIGS. 5 to 7, the energy storage device 1091 built into the power tool 100 may supply power to the electric motor 101, the external energy storage device is connected through the battery pack interface 112 to supply power to the electric motor, or both the energy storage device 1091 and the external energy storage device may simultaneously supply power to the electric motor 101. Alternatively, the external energy storage device is connected through the battery pack interface 112 to supply power to the built-in energy storage device 109.

The capacitor battery is disposed to power the power tool so that a power supply device of the power tool has the advantages of a larger discharge rate, lower cost, and longer battery life.

In an example, as shown in FIG. 8, on the basis that the power tool 100 includes the first energy storage device 103 and the second energy storage device 104, a controller 106 and a charging circuit 105 are added. The controller 106 and the charging circuit 105 are used for the first energy storage device 103 to charge the second energy storage device 104 or for the second energy storage device 104 to charge the first energy storage device 103.

It is to be understood that the first energy storage device 103 is detachably mounted on the housing 102. When the electric motor of the power tool 100 needs electricity for working, the first energy storage device 103 may supply power to the power tool 100. When the power tool 100 does not need electricity, the first energy storage device 103 may be detached and mounted to another power tool to supply power to another power tool so that one battery can be used by multiple machines. Alternatively, when the electric motor of the power tool 100 needs electricity for working and the first energy storage device 103 has low power, the first energy storage device 103 may be detached and replaced with a new first energy storage device. Additionally, the first energy storage device 103 may charge the second energy storage device 104 when the second energy storage device 104 needs to be charged and the first energy storage device 103 satisfies a charging condition.

In another example, the second energy storage device 104 is detachably mounted on the housing 102. When the electric motor of the power tool 100 needs electricity for working, the second energy storage device 104 may supply power to the power tool 100. When the power tool 100 does not need electricity, the second energy storage device 104 may be detached and mounted to another power tool to supply power to another power tool so that one battery can be used by multiple devices. Alternatively, when the electric motor of the power tool 100 needs electricity for working and the second energy storage device 104 has low power, the second energy storage device 104 may be detached and replaced with a new second energy storage device 104. Additionally, the second energy storage device 104 may charge the first energy storage device 103 when the first energy storage device 103 needs to be charged and the second energy storage device 104 satisfies the charging condition.

The first energy storage device 103 and the second energy storage device 104 can both store electrical energy in advance. Thus, the user is prevented from the inconvenience to pull a wire to connect the power tool 100 in operation to a power supply. Moreover, the first energy storage device 103 can be replaced or recharged so that the power tool 100 can resume working, greatly facilitating the use of the user.

In an example, the charging circuit 15 may include a power switch element (switch transistor). When determining that the second energy storage device 104 needs to be charged, the controller 106 may control the power switch element in the charging circuit 15 to be turned on so that the first energy storage device 103 charges the second energy storage device 104. One energy storage device inside the power tool 100 charges the other energy storage device, reducing a charging interface. When determining that the second energy storage device 104 does not need to be charged, the controller 106 may control the charging circuit 15 to be open to cut off a circuit between the first energy storage device 103 and the second energy storage device 104.

Specifically, whether the second energy storage device 104 needs to be charged is determined by the method below. As shown in FIG. 10, the control method includes S101 and S102.

In S101, the remaining power of the first energy storage device 103 and the remaining power of the second energy storage device 104 are detected.

In S102, according to the remaining power of the first energy storage device 103 and the remaining power of the second energy storage device 104, the first energy storage device 103 is controlled to charge the second energy storage device 104.

Optionally, that according to the remaining power of the first energy storage device 103 and the remaining power of the second energy storage device 104, the first energy storage device 103 is controlled to charge the second energy storage device 104 includes the step below.

When the remaining power of the first energy storage device 103 is greater than or equal to first preset power and the remaining power of the second energy storage device 104 is less than or equal to second preset power, the first energy storage device 103 is controlled to charge the second energy storage device 104.

It is to be understood that when the first energy storage device 103 and the second energy storage device 104 can jointly supply power to the electric motor 101, the controller 106 may detect the remaining power of the first energy storage device 103 and the remaining power of the second energy storage device 104 in real time. When the remaining power of the first energy storage device 103 is greater than or equal to the first preset power and the remaining power of the second energy storage device 104 is less than or equal to the second preset power, the first energy storage device 103 is controlled to charge the second energy storage device 104. The first preset power may be ⅓ of the total power of the first energy storage device 103, and the second preset power may be 1/10 of the total power of the second energy storage device 104. That is to say, in the case where the first energy storage device 103 satisfies its own power and the second energy storage device 104 needs to be charged, the controller 106 may control the first energy storage device 103 to charge the second energy storage device 104. Thus, external charging terminals of the second energy storage device 104 are omitted. The first energy storage device 103 charges the second energy storage device 104, which is more convenient and efficient.

In the preceding example, the remaining power may be detected by a battery power manager.

In an example, the first energy storage device 103 and the second energy storage device 104 may supply power to the power tool alone or simultaneously. For example, the first energy storage device 103 and the second energy storage device 104 may jointly supply power to the power tool 100 when the power tool 100 needs to output large power or large torque or in other working conditions.

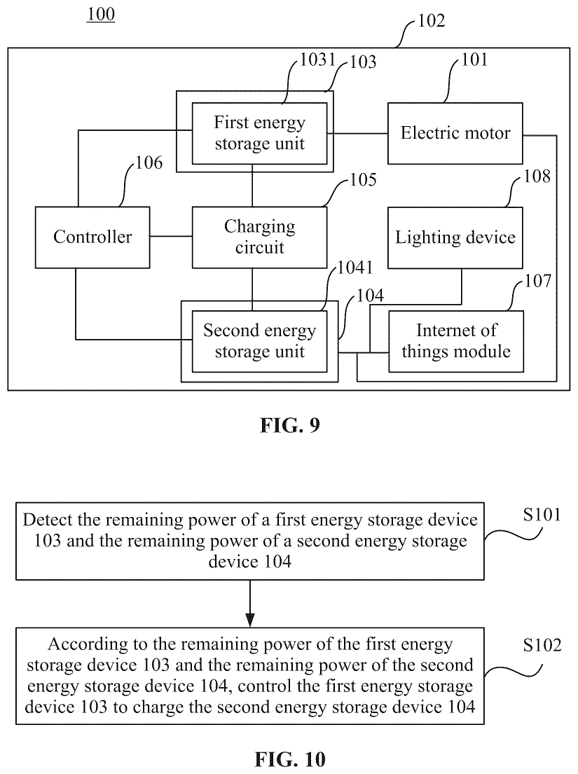

Optionally, as shown in FIG. 9, the power tool 100 further includes the Internet of things module 107 electrically connected to the second energy storage device 104, and the second energy storage device 104 supplies power to the Internet of things module 107. The power tool 100 further includes the lighting device 108 electrically connected to the second energy storage device 104, and the second energy storage device 104 supplies power to the lighting device 108.

In the preceding example, the capacity ratio of the second energy storage device 104 to the first energy storage device 103 is less than or equal to 1.

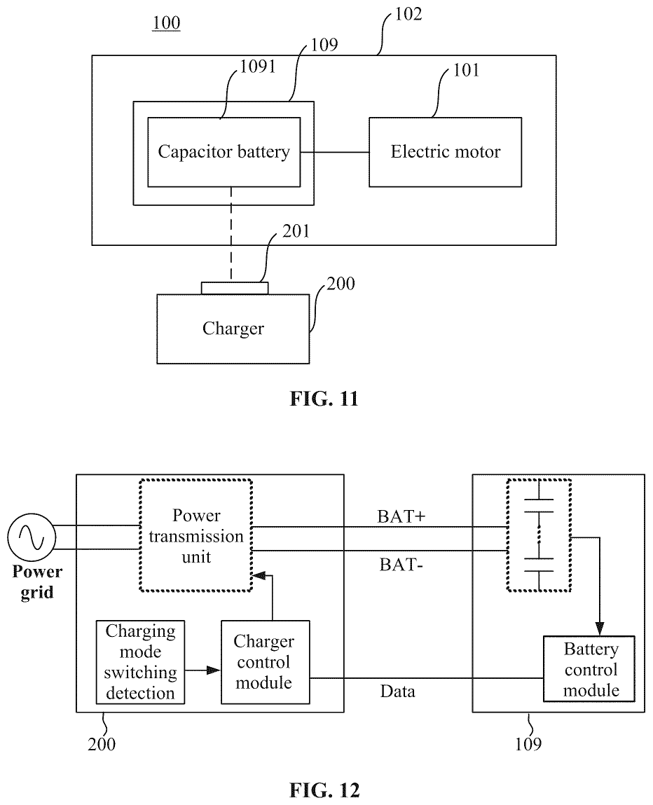

In an example, as shown in FIG. 11, on the basis that the power tool 100 has one energy storage device 109, the energy storage device 109 is charged by an external charger 200. Alternatively, on the basis that two energy storage devices are provided, a charging interface is retained for only one energy storage device, and the other energy storage device is internally charged by the one energy storage device, when the external energy storage device is connected through the battery pack interface 112 to supply power to the energy storage device 109 with the battery pack interface, the energy storage device 109 includes contact terminals exposed on a surface of the housing 102, and a charging interface 201 includes terminals matching the contact terminals. Alternatively, the energy storage device 109 is closely attached to the inside of the housing 102, and the charging interface 201 includes a wireless charging coil. Alternatively, the power tool 100 further includes a battery pack coupling portion for detachably mounting a battery pack, and the battery pack can charge the energy storage device 109.

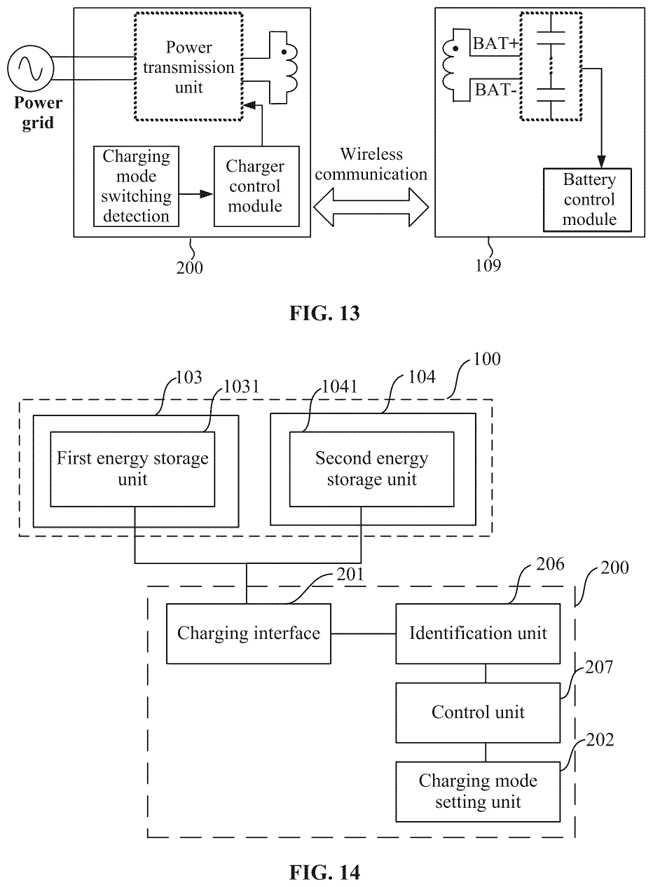

That is to say, the charged energy storage device 109 may supply power to the electric motor 101 of the power tool 100 and may be disposed in the power tool 100. In summary, the external energy storage device may charge the energy storage device 109 in three manners. As shown in FIG. 12, in a first manner, contact terminals are disposed in the charging interface 201, and the contact terminals are also disposed on the energy storage device 109. When the terminals in the charging interface 201 are in contact with the terminals on the energy storage device 109, the charger 200 may charge the energy storage device 109. This manner can reduce poor contact during charging. As shown in FIG. 13, in a second manner, the wireless charging coil is disposed in the charging interface 201, and the energy storage device 109 is charged through wireless charging. This manner can reduce an arrangement of wires. In a third manner, the detachable battery pack is disposed in the power tool 100, and the energy storage device 109 is charged by the battery pack. The charging is more convenient in this manner. Therefore, the energy storage device 109 is charged in the three manners: the contact terminals, the wireless charging coil, and the battery pack so that the energy storage device 109 in need of power can be supplemented in time.

Optionally, a charge rate at which the charger 200 charges the energy storage device 109 is greater than or equal to 5 C and less than 50 C.

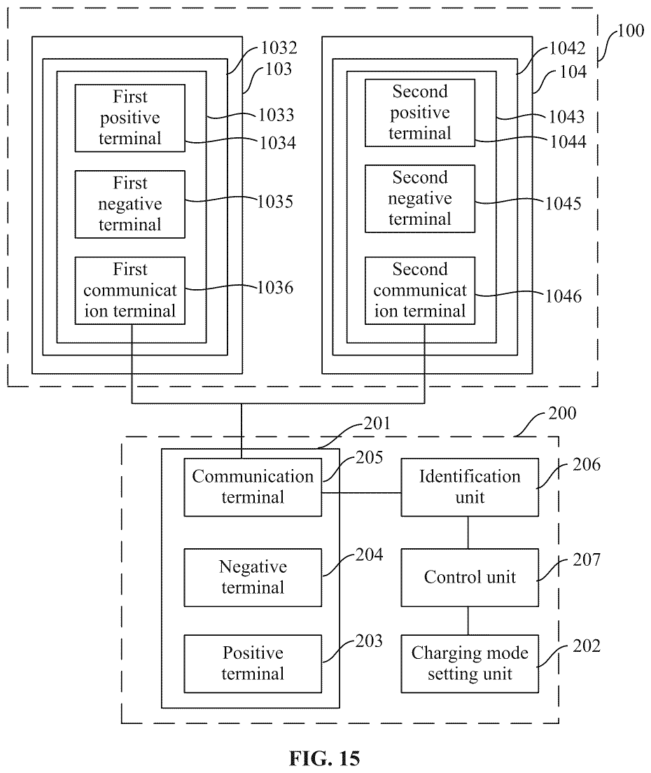

In an example, as shown in FIGS. 14 and 15, the power tool 100 includes the first energy storage device 103 and the second energy storage device 104. When both the two energy storage devices are charged by the charger 200, the charger 200 includes an identification unit 206, a control unit 207, and a charging mode setting unit 202. It is to be understood that the charger 200 further includes one charging interface 201.

It is to be noted that the first energy storage device 103 and the second energy storage device 104 may be located in the power tool 100, where the first communication terminal 1036 in the first battery pack interface 1033 in the first energy storage device 103 may communicate with a communication terminal 205 in the charging interface 201, the identification unit 206 may identify that the communication terminal 205 communicates with the first communication terminal 1036, and the control unit 207 controls, according to information identified by the identification unit 206, the charger 200 to charge the first energy storage device 103. Similarly, the second communication terminal 1046 in the second battery pack interface 1043 in the second energy storage device 104 may communicate with the communication terminal 205 in the charging interface 201, the identification unit 206 may identify that the communication terminal 205 communicates with the second communication terminal 1046, and the control unit 207 controls, according to information identified by the identification unit 206, the charger 200 to charge the second energy storage device 104. When the charger 200 charges the first energy storage device 103, a positive terminal 203 in the charging interface 201 may be electrically connected to the first positive terminal 1034, and a negative terminal 204 may be electrically connected to the first negative terminal 1035 so that the first energy storage device 103 is charged. When the charger 200 charges the second energy storage device 104, the positive terminal 203 in the charging interface 201 may be electrically connected to the second positive terminal 1044, and the negative terminal 204 may be electrically connected to the second negative terminal 1045 so that the second energy storage device 104 is charged.

In an example, one charging interface 201 is provided and may include two sets of positive and negative terminals which are retractable.

That is to say, the charging interface 201 may include a first charging positive terminal, a first charging negative terminal, a second charging positive terminal, and a second charging negative terminal and thus can match different types of energy storage devices. When the charger 200 charges the first energy storage device 103, the first charging positive terminal in the charging interface 201 may be electrically connected to the first positive terminal 1034, and the first charging negative terminal may be electrically connected to the first negative terminal 1035 so that the first energy storage device 103 is charged. When the charger 200 charges the second energy storage device 104, the second charging positive terminal in the charging interface 201 may be electrically connected to the second positive terminal 1044, and the second charging negative terminal may be electrically connected to the second negative terminal 1045 so that the second energy storage device 104 is charged. The two sets of positive and negative terminals are retractable. That is, when the charging interface 201 is coupled to the first battery pack interface 1033, a first set of positive and negative terminals extends and a second set of positive and negative terminals retracts; when the charging interface 201 is coupled to the second battery pack interface 1043, the second set of positive and negative terminals extends and the first set of positive and negative terminals retracts. Thus, positive and negative terminals are prevented from being exposed and the short circuit between terminals is avoided.

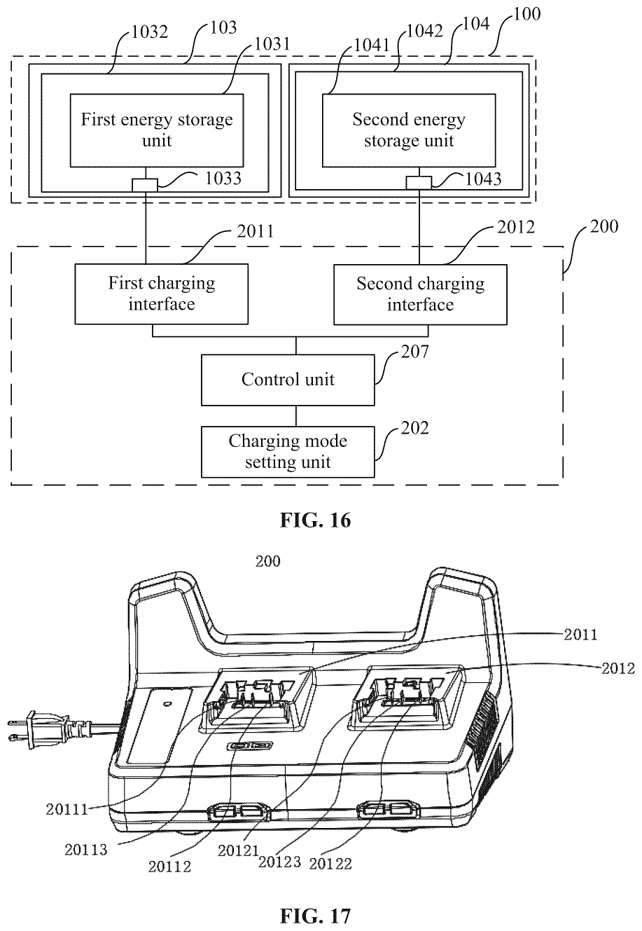

In an example, on the basis that the charging interface 201 includes the two sets of positive and negative terminals, each set of positive and negative terminals in the charging interface 201 may be disposed in one charging interface. That is to say, as shown in FIG. 16, the first set of positive and negative terminals is disposed in a first charging interface 2011, and the second set of positive and negative terminals is disposed in a second charging interface 2012. The first charging interface 2011 can be coupled to the first interface 1033; and the second charging interface 2012 can be coupled to the second interface 1043. The interfaces may be coupled in three manners: the contact terminals, the wireless charging coil, and the battery pack.

The charger 200 further includes the control unit 207, and the control unit 207 is electrically connected to the first charging interface 2011, the second charging interface 2012, and the charging mode setting unit 202 separately. When the first charging interface 2011 is coupled to the first energy storage device 103, the control unit 207 controls the charger 200 to charge the first energy storage device 103 in a normal charging mode. When the second charging interface 2012 is coupled to the second energy storage device 104, the control unit 207 controls the charger 200 to charge the second energy storage device 104 in a charging mode set by the charging mode setting unit.

It is to be understood that as shown in FIG. 17, when the contact terminals are used for coupling, the charger 200 includes the first charging interface 2011 and the second charging interface 2012, where the first charging interface 2011 includes a first charging positive terminal 20111, a first charging negative terminal 20112, and a first charging communication terminal 20113; and the second charging interface 2012 includes a second charging positive terminal 20121, a second charging negative terminal 20122, and a second charging communication terminal 20123.

The first battery pack interface 1033 in the first energy storage device 103 may include the first positive terminal, the first negative terminal, and the first communication terminal, and the second battery pack interface 1043 in the second energy storage device 104 may include the second positive terminal, the second negative terminal, and the second communication terminal. Thus, when the first communication terminal communicates with the first charging communication terminal, the first charging interface 2011 is coupled to the first interface 1033 so that the first charging positive terminal is electrically connected to the first positive terminal, the first charging negative terminal is electrically connected to the first negative terminal, and the charger 200 charges the first energy storage device 103; when the second communication terminal communicates with the second charging communication terminal, the second charging interface 2012 is coupled to the second interface 1043 so that the second charging positive terminal is electrically connected to the second positive terminal, the second charging negative terminal is electrically connected to the second negative terminal, and the charger 200 charges the second energy storage device 104. Two charging interfaces are disposed on the charger 200 so that in some circumstances, the first energy storage device 103 and the second energy storage device 104 can be charged simultaneously. Moreover, two sets of terminals are arranged, which can be adapted to the terminals of different types of energy storage devices.

The preceding communication terminal may be a communication device such as Bluetooth, Wi-Fi, or radio frequency.

It is to be understood that when charging the first energy storage device 103 (the ternary lithium battery or the lithium iron phosphate battery), the charger 200 charges the first energy storage device 103 in the normal charging mode. When charging the second energy storage device 104 (the capacitor battery), the charger 200 charges the second energy storage device 104 in the normal charging mode or a fast charging mode. The charging mode may be set by the charging mode setting unit 202.

A charge rate in the normal charging mode is less than 5 C. A charge rate in the fast charging mode is greater than or equal to 5 C and less than 50 C, where C is the unit of a charge and discharge rate. The battery can be fully charged within 20 minutes at a rate greater than 5 C. The battery is charged at a rate less than 50 C for the reason that a power distribution line consumes low power and generates a small amount of heat and so no heat sink is disposed.

In an example, when the energy storage device in the power tool is charged by the battery pack, the battery pack includes a housing; a power tool interface connected to the power tool and including a terminal assembly; multiple cell units accommodated in the housing, where the multiple cell units are connected in a combination of series and parallel connections and electrically connected to the terminal assembly; and the multiple cell units are capacitor batteries; and a charging control unit configured to control the charging of the multiple cell units.

It is to be noted that the battery pack is provided with the multiple cell units which are all the capacitor batteries so that when the battery pack supplies power to the power tool or charges the first energy storage device or the second energy storage device, the charge rate is fast and the service life is long.

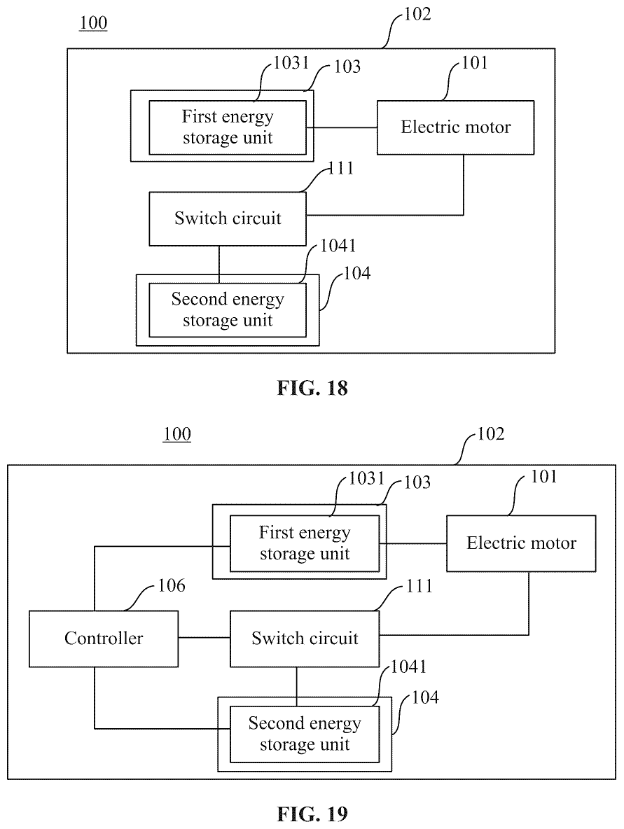

In an example, when the power tool 100 includes the first energy storage device 103 and the second energy storage device 104, the second energy storage device 104 supplies power to the electric motor 101 only under certain conditions. As shown in FIG. 18, a switch circuit 111 is disposed between the second energy storage device 104 and the electric motor 101. When a voltage of the first energy storage device 103 is lower than a voltage of the second energy storage device 104, the switch circuit 111 is closed so that the second energy storage device 104 supplies power to the electric motor 101.

### The Switch Circuit 111 Includes a Diode.

In normal circumstances, when the electric motor 101 of the power tool 100 is working, the first energy storage device 103 supplies power. When the voltage of the first energy storage device 103 is lower than the voltage of the second energy storage device 104, the switch circuit 111 is on.

It is to be noted that the voltage supplied by the first energy storage device 103 to the electric motor 101 may be acquired from a power supply line of the electric motor 101. A voltage at one end of the switch circuit 111 is the voltage supplied by the first energy storage device 103 to the electric motor 101, and a voltage at the other end is the voltage of the second energy storage device 104. When the voltage at the end of the switch circuit 111 connected to the electric motor 101 is lower than the voltage of the second energy storage device 104, the switch circuit 111 is on so that the second energy storage device 104 supplies power to the electric motor 101. For example, the switch circuit 111 may be the diode, a cathode of the diode is connected to the electric motor 101, and an anode of the diode is connected to the second energy storage device 104. When a voltage difference between two ends of the diode changes, the diode is turned on. A voltage difference between a highest voltage of the first energy storage device 103 and the voltage of the second energy storage device 104 is lower than a breakdown voltage of the diode.

The switch circuit 111 further includes a synchronous rectifier.

A gate of the synchronous rectifier is connected to the second energy storage device 104, and a drain of the synchronous rectifier is connected to the electric motor 101. When a voltage between the gate and the drain is positive, the synchronous rectifier is turned on so that the second energy storage device 104 supplies power to the electric motor 101.

The switch circuit 111 includes a field-effect transistor. As shown in FIG. 19, when the switch circuit 111 includes the field-effect transistor, the power tool 100 further includes the controller 106 configured to detect voltages at two ends of the field-effect transistor and control the field-effect transistor to turn on or off.

The voltages at the two ends of the field-effect transistor are detected by the controller 106. When the voltage of the first energy storage device 103 is lower than the voltage of the second energy storage device 104, the switch circuit 111 is controlled to be closed so that the second energy storage device 104 supplies power to the electric motor 101. On the contrary, when the voltage of the first energy storage device 103 is higher than the voltage of the second energy storage device 104, the switch circuit 111 is controlled to be open to cut off the power supply from the second energy storage device 104 to the electric motor 101.

In the preceding example, in the switch circuit 111, the width of a PCB copper foil is greater than or equal to 1.5 cm. In the switch circuit 111, the PCB copper foil is windowed. The thickness of the PCB copper foil is increased or the PCB copper foil is windowed so that an overcurrent capability of the copper foil is enhanced to adapt to a relatively large current in a discharge circuit of the second energy storage device 104.

Thus, in this example, when the voltage of the first energy storage device 103 is insufficient, the switch circuit 111 is closed in time so that the second energy storage device 104 supplies power to the electric motor 101, and the electric motor 101 can work continuously during operation, avoiding the operation interruption of the electric motor 101 due to a low voltage.

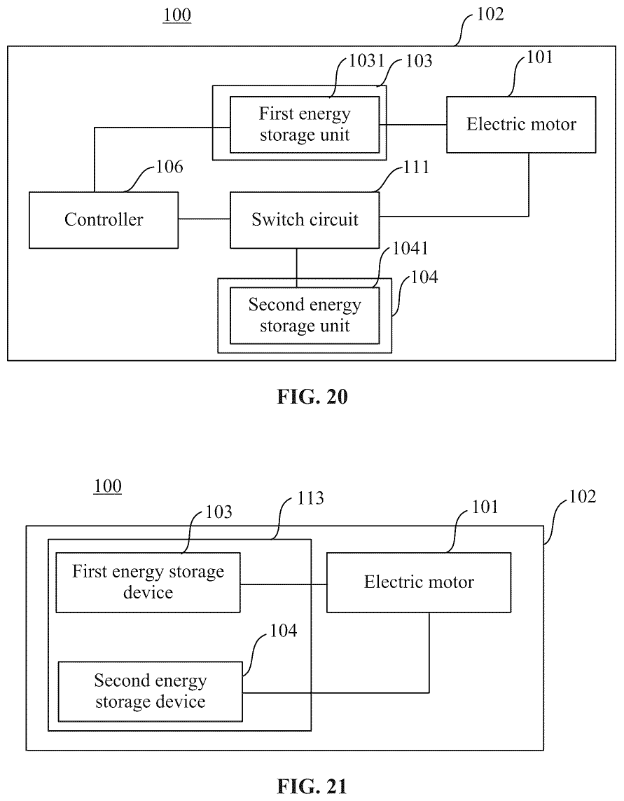

In an example, as shown in FIG. 20, on the basis that the switch circuit 111 is disposed in the power tool 100, in addition to voltage parameters of the first energy storage device 103 and the second energy storage device 104, the controller 106 may detect a working parameter of the first energy storage device 103 to control the switch circuit 111 to be closed or open.

Optionally, the working parameter may be the SoC (also referred to as the remaining power). Alternatively, the working parameter may be an SoH (also referred to as an accumulator capacity, health degree, or performance state).

It is to be understood that the controller 106 may detect the working parameter of the first energy storage device 103 in real time, such as the SoC and/or the SoH. When the detected working parameter is the SoC, if the SoC of the first energy storage device 103 is lower than a preset threshold, the controller 106 controls the switch circuit 111 to be closed so that the second energy storage device 104 can supply power to the electric motor 101 through the switch circuit 111. If the SoC of the first energy storage device 103 is higher than the preset threshold, the controller 106 may control the switch circuit 111 to be open so that the second energy storage device 104 stops supplying power to the electric motor 101. The switch circuit 111 may be a switch transistor (such as a triode or a metal-oxide-semiconductor (MOS) transistor).

When the detected working parameter is the SoH, if the SoH of the first energy storage device 103 is lower than a set threshold, indicating that the performance of the first energy storage device 103 is degraded, the controller 106 may control the switch circuit 111 to be closed so that the second energy storage device 104 can supply power to the electric motor 101 through the switch circuit 111. If the SoH of the first energy storage device 103 is higher than the set threshold, the controller 106 may control the switch circuit 111 to be open so that the second energy storage device 104 stops supplying power to the electric motor 101.

When the detected working parameter includes the SoC and the SoH, if any one of the SoC and the SoH of the first energy storage device 103 is lower than a threshold, the controller 106 may control the switch circuit 111 to be closed so that the second energy storage device 104 can supply power to the electric motor 101 through the switch circuit 111. Conversely, the controller 106 may control the switch circuit 111 to be open so that the second energy storage device 104 stops supplying power to the electric motor 101. When the controller 106 detects multiple working parameters of the first energy storage device 103, the first energy storage device 103 may be detected in multiple aspects so that a deficiency of the first energy storage device 103 can be detected in time, the switch circuit 111 is closed in time, and the second energy storage device 104 supplies power to the electric motor 101, thereby supplementing the power supply of the electric motor 101 in time and ensuring the continuous operation of the electric motor 101.

The preceding example illustrates that the second energy storage device 104 supplies power to the electric motor 101 under certain conditions. In another example, other manners may be selected to control the first energy storage device 103 and/or the second energy storage device 104 to supply power to the electric motor 101.

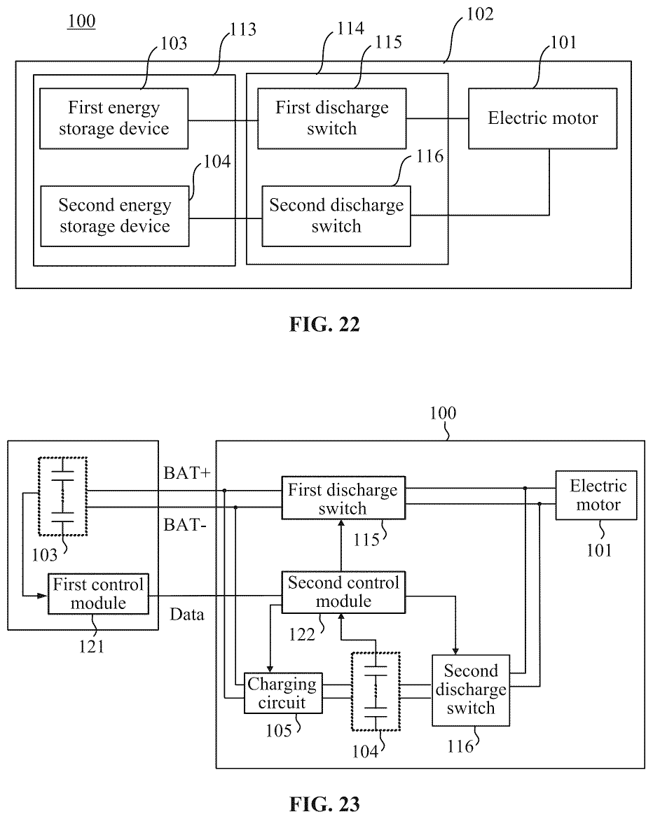

As shown in FIGS. 21 and 22, the first energy storage device 103 and the second energy storage device 104 may be collectively referred to as a power supply assembly 113, and the power supply assembly 113 supplies power to the electric motor 101. That is to say, the first energy storage device 103 and/or the second energy storage device 104 may supply power to the electric motor 101. For example, when the first energy storage device 103 supplies power to the electric motor 101, the second energy storage device 104 is idle; when the second energy storage device 104 supplies power to the electric motor 101, the first energy storage device 103 is idle; or the first energy storage device 103 and the second energy storage device 104 simultaneously supply power to the electric motor 101. In the preceding power supply example, a discharge rate of at least one of the first energy storage device 103 and the second energy storage device 104 is greater than or equal to 10 C and less than or equal to 50 C, so as to ensure that the entire discharge circuit is protected from being burned by a large current on the basis that the electric motor 101 can work normally.

Optionally, as shown in FIG. 22, a discharge unit 114 is further included, where the discharge unit 114 includes a first discharge switch 115. When the first discharge switch 115 is turned on, the first energy storage device 103 supplies power to the electric motor 101. The discharge unit 114 further includes a second discharge switch 116. When the second discharge switch 116 is turned on, the second energy storage device 104 supplies power to the electric motor 101.

Optionally, when the power tool 100 is in a stable working condition, the first discharge switch 115 is turned on; when the power tool 100 is in a large-current working condition, the first discharge switch 115 and the second discharge switch 116 are turned on at the same time.

In an example, when the tool works in the stable working condition, the discharge rate of at least one energy storage device is less than or equal to 30 C; when the tool works in the large-current working condition, the discharge rate of at least one energy storage device is greater than 30 C.

In an example, the first discharge switch 115 and the second discharge switch 116 may be disposed outside as buttons and be triggered according to a requirement of the user. When the first discharge switch 115 is turned on, for example, it is a working condition in a first gear. When the second discharge switch 116 is turned on, for example, it is a working condition in a second gear. When the first discharge switch 115 and the second discharge switch 116 are both turned on, for example, it is a working condition in a third gear. Working conditions in the gears are different. Thus, through the discharge unit 114, the user can directly and autonomously control the first energy storage device 103 and/or the second energy storage device 104 to supply power to the electric motor 101 according to the requirement of the user.

The first discharge switch 115 and the second discharge switch 116 may each be a mechanical switch.

Thus, when the voltage of the first energy storage device is insufficient to supply power to the electric motor, the second energy storage device may be connected to supply power to the electric motor to supplement the power supply of the electric motor in time, or the corresponding energy storage device may be triggered by the user or according to a different working condition to supply power to the electric motor 101, so as to ensure the continuous operation of the power tool.

In an example, as shown in FIG. 23, the first energy storage device 103 is detachably mounted to the power tool 100, the first energy storage device 103 is connected to a first control module 121, the first control module 121 is configured to detect the power of the first energy storage device 103 and send the power to a second control module 122, and the second control module 122 is connected to the second energy storage device 104 and configured to detect the power of the second energy storage device 104. When the power tool 100 is in the stable working condition, the first discharge switch 115 is turned on, and the first energy storage device 103 supplies power to the electric motor 101 through the first discharge switch 115. When the power tool 100 is in an instantaneous large-current working condition, the second control module 122 controls the second discharge switch 116 to be turned on, and the first energy storage device 103 and the second energy storage device 104 simultaneously supply power to the electric motor 101. When the second control module 122 detects that the power of the second energy storage device 104 is low and the first control module 121 detects that the power of the first energy storage device 103 satisfies a charging requirement, the charging circuit 105 may be controlled to be closed so that the first energy storage device 103 charges the second energy storage device 104.

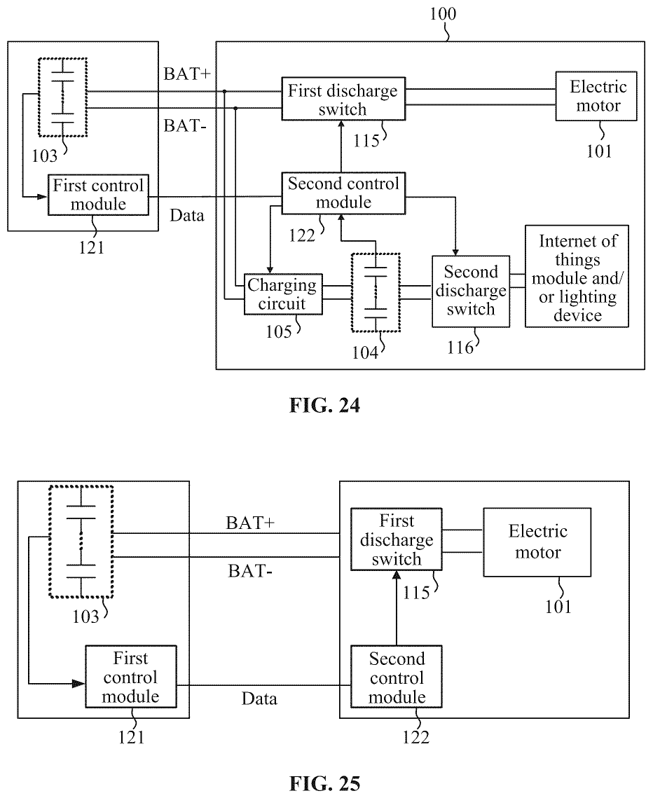

In an example, as shown in FIG. 24, the second energy storage device 104 may also supply power to the Internet of things module 107 and/or the lighting device 108 through the second discharge switch 116.

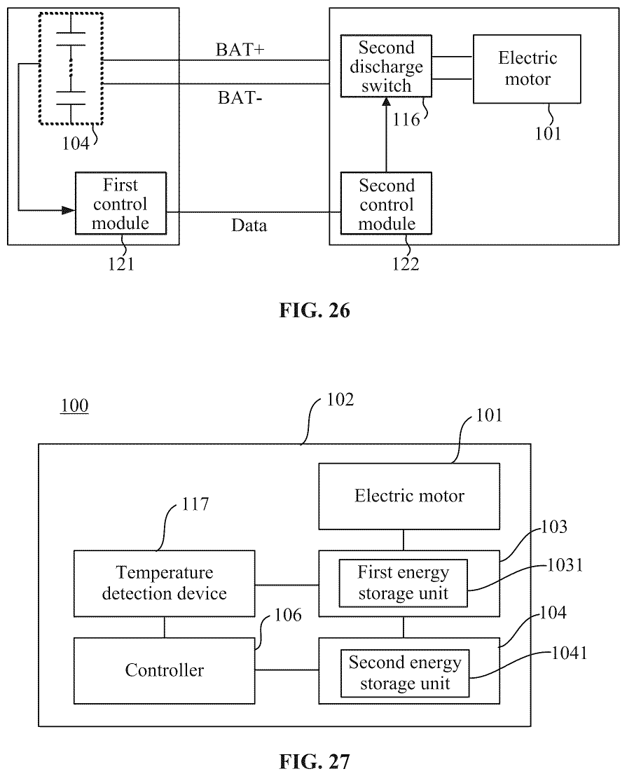

In an example, as shown in FIGS. 25 and 26, if only one energy storage device supplies power to the electric motor 101, the first control module 121 may detect the power of the energy storage device, and the second control module 122 may control, according to the power of the energy storage device, the discharge switch to be turned on or off to implement or cut off the power supply to the electric motor 101.

In an example, the first energy storage device 103 may be a lithium battery pack and the second energy storage device 104 may be a capacitor battery pack. The power tool can be compatible with the lithium battery pack and the capacitor battery pack to obtain electrical energy.

In an example, as shown in FIG. 27, on the basis that the power tool 100 includes the first energy storage device 103 and the second energy storage device 104, a temperature detection device 117 and the controller 106 are added, where the temperature detection device 117 is configured to detect the temperature of the first energy storage device 103 and send the temperature to the controller 106; and the temperature detection device 117 is disposed in the first energy storage device 103. That is, a temperature sensor may be directly in the first energy storage device 103.

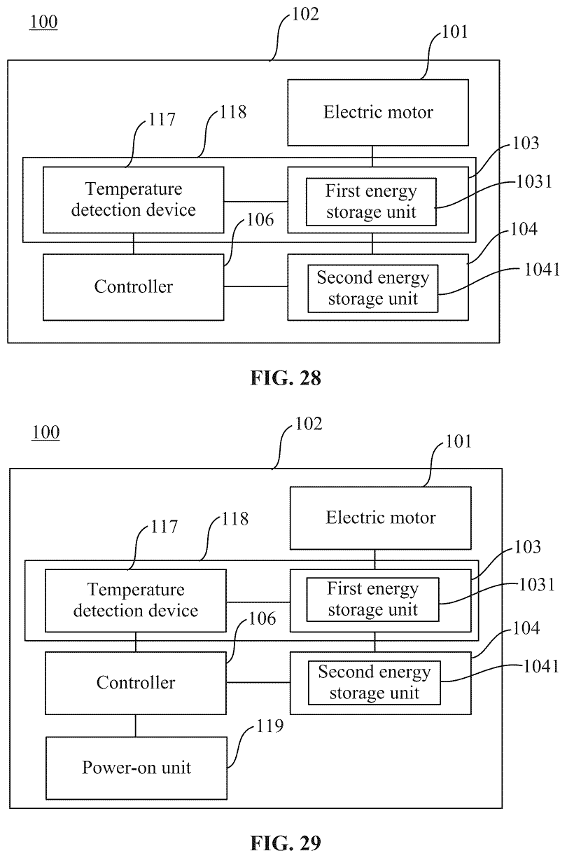

In an example, as shown in FIG. 28, the housing 102 is formed with the mounting portion 118, the first energy storage device 103 is mounted to the mounting portion 118, and the temperature detection device 117 is disposed on the mounting portion 118. Thus, the first energy storage device 103 and the temperature detection device 117 are more concentrated by being mounted to the mounting portion 118, and the temperature detection device 117 can better detect the temperature of the first energy storage device 103.

The controller 106 is configured to, when the temperature of the first energy storage device 103 is lower than or equal to a first preset temperature and higher than or equal to a second preset temperature, control the second energy storage device 104 to preheat the first energy storage device 103.

It is to be understood that the first energy storage device 103 supplies power to the electric motor 101, but the energy storage device generally has an appropriate range of working temperatures. When in a low temperature environment, that is, below appropriate working temperatures, the energy storage device has lower discharge efficiency. Therefore, the working temperature of the first energy storage device 103 needs to be guaranteed.

The temperature detection device 117 detects the temperature of the first energy storage device 103. When the temperature of the first energy storage device 103 is between the second preset temperature and the first preset temperature, the controller 106 may control the second energy storage device 104 to preheat the first energy storage device 103. When the temperature is higher than the first preset temperature, the second energy storage device 104 may stop preheating the first energy storage device 103. The second preset temperature is −40° C. The first preset temperature is −20° C. Thus, when the power tool 100 is used at a relatively low temperature, the second energy storage device 104 preheats the first energy storage device 103 to prevent the discharge performance of the first energy storage device 103 from being affected in the low temperature environment and ensure the normal operation of the electric motor 101.

In the preceding example, the temperature detection device 117 may be the temperature sensor.

In an example, a preheating manner mainly includes that when the controller 106 controls the second energy storage device 104 to preheat the first energy storage device 103, the second energy storage device 104 discharges to a load, and the load is adjacent to the first energy storage device 103.

It is to be understood that the load may be a resistor or a heating wire, and the second energy storage device 104 discharges to the resistor or the heating wire to heat the resistor or the heating wire. Since the load is adjacent to the first energy storage device 103, heat generated through the heating of the resistor or the heating wire may be transferred to the first energy storage device 103 so that the first energy storage device 103 is preheated.

In an example, the preheating manner mainly includes that the second energy storage device 104 is physically connected to the first energy storage device 103 through a thermally conductive material.

The thermally conductive material may be a metal with good thermal conductivity, such as copper or aluminum, or other thermally conductive materials, which are not specifically limited in the present application. The first energy storage device 103 is physically connected to the second energy storage device 104 through the thermally conductive material. When the second energy storage device 104 discharges, the thermally conductive material may be heated and transfer heat to the first energy storage device 103 so that the first energy storage device 103 is preheated.

In an example, the preheating manner mainly includes that the second energy storage device 104 is adjacent to the first energy storage device 103.

In other examples, the second energy storage device 104 is adjacent to the first energy storage device 103, and the controller 106 may control the second energy storage device 104 to directly discharge to the first energy storage device 103 to preheat the first energy storage device 103.

To save energy and prevent the temperature sensor from being in a detection state all the time, as shown in FIG. 29, the power tool 100 further includes a power-on unit 119 configured to send a first signal to the controller 106. When the controller 106 receives the first signal and the temperature of the first energy storage device 103 is lower than or equal to the first preset temperature and higher than or equal to the second preset temperature, the second energy storage device 104 is controlled to preheat the first energy storage device 103.

In an example, the first signal is generated in the following manner: the power-on unit 119 includes an actuator, and when the actuator is operated to a preset position, the power-on unit 119 sends the first signal to the controller 106.

That is to say, after the power tool 100 is powered on, the temperature detection device 117 starts to detect the temperature of the first energy storage device 103, and when the temperature of the first energy storage device 103 is lower than or equal to the first preset temperature and higher than or equal to the second preset temperature, the second energy storage device 104 is controlled to preheat the first energy storage device 103. The following case is avoided: the temperature detection device 117 always detects the temperature of the first energy storage device 103 and the second energy storage device 104 always preheats the first energy storage device 103, thereby saving energy. The power-on unit 119 may include the actuator which may be understood as a switch button of the power tool 100.

In an example, the first signal is generated in the following manner: the power tool 100 further includes a wireless communication interface for making the power tool 100 communicatively connected to a remote device. When receiving a standby signal sent by the remote device, the power-on unit 119 sends the first signal to the controller 106.

That is to say, the standby signal may be sent by the remote device. For example, before the user reaches a construction site, the user may perform a remote operation to preheat the first energy storage device 103. When the user reaches the construction site, the first energy storage device 103 has been preheated and can be used directly, saving time.

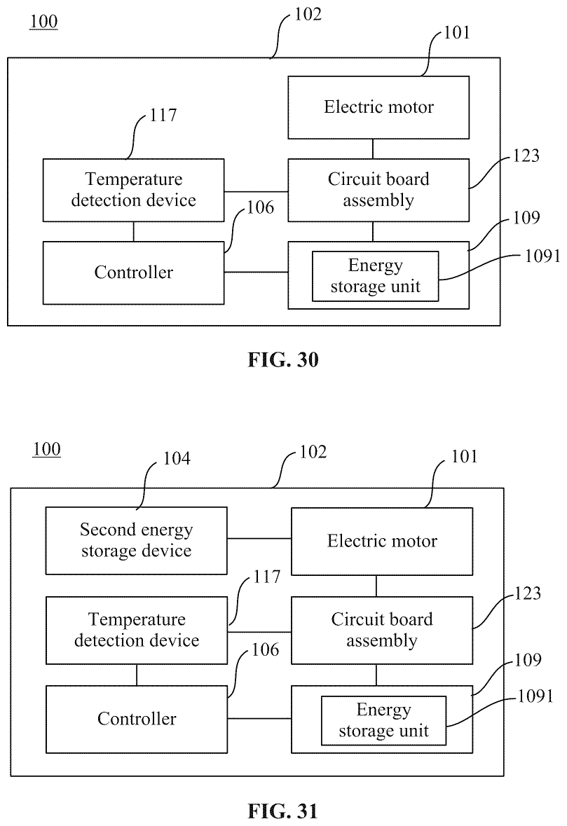

In an example, as shown in FIG. 30, on the basis that the power tool 100 includes one energy storage device, the power tool 100 is further provided with a circuit board assembly 123 configured to drive the electric motor 101 to rotate and the temperature detection device 117 configured to detect the temperature of at least one element of the circuit board assembly 123 and send the temperature to the controller 106. The controller 106 is configured to control the energy storage device 109 to preheat the at least one element of the circuit board assembly 123 when the temperature sent by the temperature detection device 117 is lower than or equal to the first preset temperature and higher than or equal to the second preset temperature.

It is to be noted that the circuit board assembly 123 may be understood as an assembly that converts a direct current output from the energy storage device 109 into an alternating current supplied to the electric motor 101, such as an inverter. At low temperatures, some electronic elements in the circuit board assembly 123 have poor reliability; therefore, the circuit board assembly 123 needs to be preheated before the power tool 100 is used. Specifically, the temperature detection device 117 detects the temperature of the at least one element of the circuit board assembly 123, and when the temperature is lower than or equal to the first preset temperature and higher than or equal to the second preset temperature, the energy storage device 109 may be controlled to preheat the circuit board assembly 123.

Specifically, the energy storage device 109 preheats the circuit board assembly 123 in three manners. In one manner, the energy storage device 109 is adjacent to the circuit board assembly 123, and the energy storage device 109 generates heat and transfers the heat to the circuit board assembly 123. In another manner, the circuit board assembly 123 is physically connected to the energy storage device 109 through the thermally conductive material, and the energy storage device 109 discharges to release heat and transfers the heat to the circuit board assembly 123 through the thermally conductive material, which has the characteristic of fast heat transfer. In another manner, the energy storage device directly discharges to a resistor on the circuit board assembly 123 to heat the resistor and preheat the circuit board assembly 123, which has the characteristics of direct and fast preheating. In practical application, any one of the three manners may be selected for preheating, or the three manners may be set and a different preheating manner is selected according to a different temperature range. To save space, the controller 106 may be integrated on the circuit board assembly 123. The circuit board assembly 123 includes a low temperature resistant electronic element. The circuit board assembly 123 includes an electronic element that is not resistant to low temperatures.

Based on the example of FIG. 30, the power-on unit 119 may be further provided to save energy.

Optionally, as shown in FIG. 31, based on the example of FIG. 30, the power tool 100 further includes the second energy storage device 104 supplying power to the electric motor 101. It is to be understood that the second energy storage device 104 may supply power to the electric motor 101 in time when the energy storage device 109 has low power, so as to ensure the continuous operation of the electric motor 101.

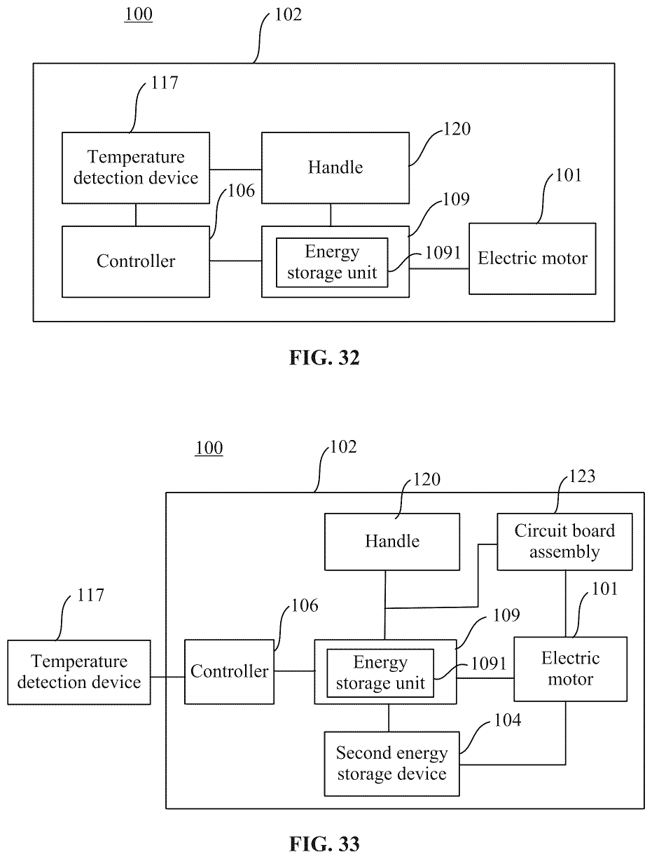

In an example, the energy storage device may preheat the handle 120 of the power tool when supplying power to the electric motor. As shown in FIG. 32, the temperature detection device 117 is configured to detect the temperature of the handle 120 and send the temperature to the controller 106. When the temperature of the handle 120 is lower than or equal to the first preset temperature and higher than or equal to the second preset temperature, the controller 106 controls the energy storage device 109 to preheat the handle 120. The energy storage device 109 is disposed in the handle 120, facilitating the direct preheating of the handle 120 and reducing a heat loss on a preheating path.

It is to be understood that when the power tool 100 is in the low temperature environment, the user feels relatively cold when holding the power tool 100, and the handle 120 is preheated so that the user can feel less cold. For a manner in which the energy storage device 109 preheats the handle 120, reference may be made to the manners in which the first energy storage device 103 and the circuit board assembly 123 are preheated in the preceding two examples, and the manner is not repeated here.

In an example, as shown in FIG. 33, the energy storage device 109 in the power tool 100 not only supplies power to the electric motor but also preheats the handle 120 and the circuit board assembly 123 under certain conditions, and the second energy storage device 104 preheats the energy storage device 109. The temperature detection device 117 is configured to detect the ambient temperature and send the ambient temperature to the controller 106.

The controller 106 is configured to control the energy storage device 109 to preheat the circuit board assembly 123 or the handle 120 when the temperature sent by the temperature detection device 117 is lower than or equal to the first preset temperature and higher than or equal to the second preset temperature.

Optionally, the power tool 100 further includes the second energy storage device 104, the second energy storage device 104 supplies power to the electric motor 101, and the controller 106 is configured to control the energy storage device 109 to preheat the second energy storage device 104 when the temperature sent by the temperature detection device 117 is lower than or equal to the first preset temperature and higher than or equal to the second preset temperature, so as to improve the performance of the power tool 100.

In an example, the first energy storage device 103 and the second energy storage device 104 may be coupled to the battery pack through the detection of the ambient temperature such that at working temperatures of the first energy storage device 103, a battery pack 113 is coupled to the first energy storage device 103 through the battery pack interface 112, and at working temperatures of the second energy storage device 104, the battery pack 113 is coupled to the second energy storage device 104 through the battery pack interface 112.

In an example, the working temperature of the power tool 100 may be detected to determine which energy storage device 104 is coupled to the battery pack interface 112. When the battery pack interface 112 is coupled to the first energy storage device 103, the working temperature of the power tool 100 is higher than or equal to the first preset temperature, and when the battery pack interface 112 is coupled to the second energy storage device 104, the working temperature of the power tool 100 is greater than or equal to the second preset temperature, where the first preset temperature is higher than the second preset temperature.

Optionally, when the battery pack interface 112 is coupled to the second energy storage device 104, the working temperature of the power tool 100 is higher than or equal to −40° C. and lower than or equal to 85° C.

Optionally, when the battery pack interface 112 is coupled to the first energy storage device 103, the working temperature of the power tool 100 is higher than or equal to −20° C. and lower than or equal to 70° C.

It is to be understood that the first energy storage device 103 is different from the second energy storage device 104. For example, the first energy storage device 103 may be the ternary lithium battery or the lithium iron phosphate battery, and the second energy storage device 104 may be the capacitor battery. These batteries have different optimal working temperature ranges. Therefore, when the power tool 100 works within different temperature ranges, different energy storage devices may be selected to supply power to the power tool so that the energy storage devices can all work within the optimal working temperature ranges. It is to be noted that the working temperature of the power tool 100 may be detected by the temperature detection device 117 to control whether the battery pack interface 112 is coupled to the first energy storage device 103 or the second energy storage device 104.

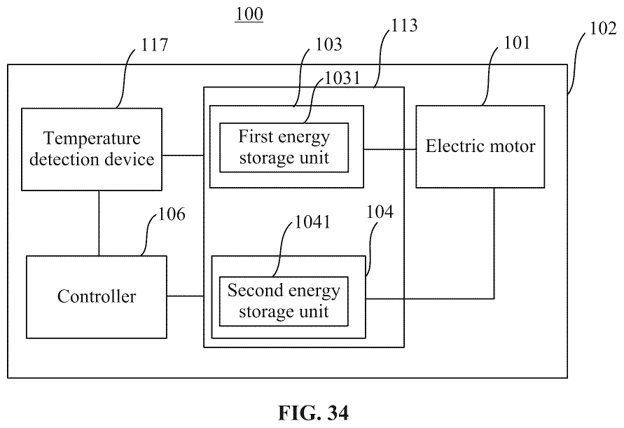

In another example, the temperature of the energy storage device may be detected to select an energy storage device that supplies power to the electric motor 101. As shown in FIG. 34, the power tool 100 includes the controller 106 configured to at least control the power supply assembly 113 to supply power to the electric motor 101.

The temperature detection device 117 is configured to detect the temperature of the power supply assembly 113 and send the temperature to the controller 106.

When the temperature of the power supply assembly 113 is lower than or equal to the first preset temperature and higher than or equal to the second preset temperature, the controller 106 selects the second energy storage device 104 to supply power to the electric motor 101.

That is to say, the power supply assembly 113 may supply power to the electric motor 101, that is, the first energy storage device 103 may be selected to supply power to the electric motor 101, or the second energy storage device 104 may be selected to supply power to the electric motor 101. Since the two energy storage devices have different working temperature ranges, when the temperature of the power supply assembly 113 is lower than or equal to the first preset temperature and higher than or equal to the second preset temperature, indicating that the second energy storage device 104 is suitable for supplying power to the electric motor 101, the second energy storage device 104 may be selected to supply power to the electric motor 101. It is to be understood that the switch transistor may be disposed between the second energy storage device 104 and a power supply circuit of the electric motor 101, and the controller 106 controls the switch transistor to be turned on or off to control whether the second energy storage device 104 supplies power to the electric motor 101.

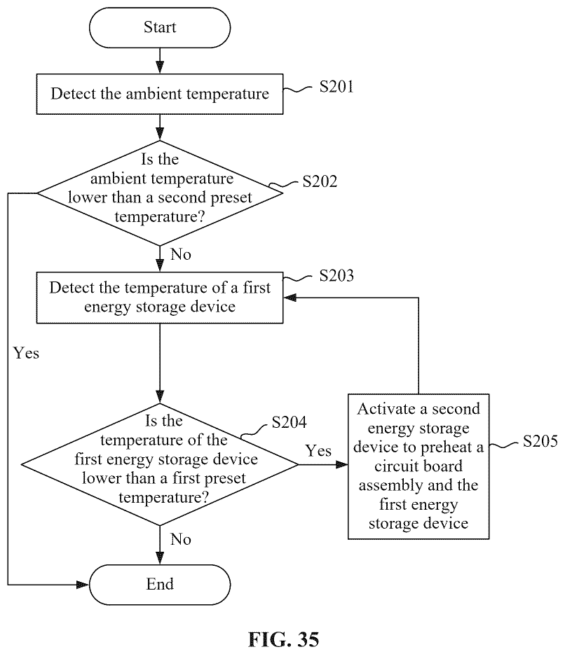

In an example, as shown in FIG. 35, S201 may be performed first to detect the ambient temperature, and S202 may be performed to determine whether the ambient temperature is lower than the second preset temperature. If so, the flow ends. If not, S203 is performed to detect the temperature of the first energy storage device. S204 is performed to determine whether the temperature of the first energy storage device is lower than the first preset temperature. If so, S205 is performed in which the second energy storage device is activated to preheat the circuit board assembly and the first energy storage device. The temperature of the first energy storage device is detected in real time. When the temperature of the first energy storage device is higher than the first preset temperature, the preheating ends.

To conclude, the power tool according to the examples of the present application includes the housing; the electric motor mounted to the housing, where the housing at least partially accommodates the electric motor; the first energy storage device supplying power to the electric motor and including the at least one first energy storage unit; the controller configured to at least control the first energy storage device to supply power to the electric motor; and the temperature detection device configured to detect the temperature of the first energy storage device and send the temperature to the controller. The power tool further includes the second energy storage device including the at least one second energy storage unit. When the temperature of the first energy storage device is lower than or equal to the first preset temperature and higher than or equal to the second preset temperature, the controller controls the second energy storage device to preheat the first energy storage device. Thus, when the power tool is operating in the low temperature environment, the second energy storage device can preheat the first energy storage device so that the first energy storage device can be preheated first in the low temperature environment and then supply power to the electric motor of the power tool, solving the problem of a failure of the first energy storage device to normally supply power to the electric motor due to an insufficient voltage at low temperatures.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A power tool, comprising:
a housing;
an electric motor mounted to the housing, wherein the housing at least partially accommodates the electric motor;
a first energy storage device supplying power to the electric motor and comprising at least one first energy storage unit;
a controller configured to at least control the first energy storage device to supply power to the electric motor;
a temperature detection device configured to detect a temperature of the first energy storage device and send the temperature to the controller; and
a second energy storage device comprising at least one second energy storage unit;
wherein, when the temperature of the first energy storage device is lower than or equal to a first preset temperature and higher than or equal to a second preset temperature, the controller controls the second energy storage device to preheat the first energy storage device.

2. The power tool according to claim 1, wherein the temperature detection device is disposed in the first energy storage device.

3. The power tool according to claim 1, wherein the housing is formed with a mounting portion, the first energy storage device is mounted to the mounting portion, and the temperature detection device is disposed on the mounting portion.

4. The power tool according to claim 1, wherein the at least one second energy storage unit is a capacitor battery.

5. The power tool according to claim 1, wherein, when the controller controls the second energy storage device to preheat the first energy storage device, the second energy storage device discharges to a load, and the load is adjacent to the first energy storage device.

6. The power tool according to claim 1, wherein the second energy storage device is physically connected to the first energy storage device through a thermally conductive material.

7. The power tool according to claim 1, wherein the second energy storage device is adjacent to the first energy storage device.

8. The power tool according to claim 1, further comprising a power-on unit configured to send a first signal to the controller, wherein, when the controller receives the first signal and the temperature of the first energy storage device is lower than or equal to the first preset temperature and higher than or equal to the second preset temperature, the controller controls the second energy storage device to preheat the first energy storage device.

9. The power tool according to claim 8, wherein the power-on unit comprises an actuator, and, when the actuator is operated to a preset position, the power-on unit sends the first signal to the controller.

10. The power tool according to claim 8, further comprising a wireless communication interface for making the power tool communicatively connected to a remote device, wherein, when receiving a standby signal sent by the remote device, the power-on unit sends the first signal to the controller.

11. A power tool, comprising:
a housing;
an electric motor mounted to the housing, wherein the housing at least partially accommodates the electric motor;
a circuit board assembly configured to drive the electric motor to rotate;
an energy storage device comprising at least one energy storage unit and connected to the circuit board assembly; and
a temperature detection device configured to detect a temperature of at least one element of the circuit board assembly and send the temperature to a controller;
wherein the controller is configured to control the energy storage device to preheat the at least one element of the circuit board assembly when the temperature sent by the temperature detection device is lower than or equal to a first preset temperature and higher than or equal to a second preset temperature.

12. The power tool according to claim 11, wherein the controller is disposed on the circuit board assembly.

13. The power tool according to claim 11, wherein the circuit board assembly comprises a low temperature resistant electronic element.

14. The power tool according to claim 11, wherein the circuit board assembly comprises an electronic element that is not resistant to low temperatures.

15. The power tool according to claim 11, wherein the at least one energy storage unit is a capacitor battery.

16. The power tool according to claim 11, wherein the energy storage device supplies power to the electric motor through the circuit board assembly.

17. The power tool according to claim 11, further comprising a second energy storage device supplying power to the electric motor.

18. The power tool according to claim 11, wherein the energy storage device is adjacent to the circuit board assembly.

19. The power tool according to claim 11, wherein the energy storage device is physically connected to the circuit board assembly through a thermally conductive material.

20. The power tool according to claim 11, wherein the circuit board assembly comprises a resistor, and the energy storage device discharges to the resistor to preheat the circuit board assembly.
